(19) United States
(12) Patent Application Publication
(10) Pub. No.: US 2015/0081465 A1
(43) Pub. Date: Mar. 19, 2015

(54) FITNESS, HEALTH AND WELLNESS SOCIAL E-COMMERCE PLATFORM

(71) Applicant: Jeff Dyment, Connecticut, CT (US)

(72) Inventor: Jeff Dyment, Connecticut, CT (US)

(21) Appl. No.: 14/217,211

(22) Filed: Mar. 17, 2014

Related U.S. Application Data
(60) Provisional application No. 61/801,087, filed on Mar. 15, 2013.

(51) Int. Cl. G06Q 30/06; G06Q 20/12; G06Q 50/00; G06Q 20/06

(52) U.S. Cl. CPC G06Q 30/0601; G06Q 20/065; G06Q 20/12; G06Q 50/01
USPC 705/26.1

(57) ABSTRACT

The present invention relates to a fitness health and wellness social e-commerce platform that provides an e-commerce platform that operates as a social network in which the interaction between fitness enthusiasts is what drives revenue into the e-commerce components.

### RELATED APPLICATIONS

This application claims the benefit of U.S. Provisional Application No. 61/801,087 filed Mar. 15, 2013, which is hereby incorporated by reference in its entirety.

### BACKGROUND OF THE DISCLOSURE

1. Field of the Disclosure

The present invention relates to a fitness, health and wellness social e-commerce platform.

2. Discussion of the Background

As a general rule, to be part of a fitness or health related ecosystem, sports and/or fitness enthusiasts must all be physically present at some specific location in order to engage in fitness related activities. This represents an obstacle to people who wish to train from distant locations or work out with people in different locations. Another obstacle faced by fitness enthusiasts is the difficulty of finding a gym or a class that fits their individual needs when traveling away from home. Another problem faced by fitness enthusiasts is the need for an e-commerce platform where they can buy or sell fitness related content or goods as well as interact with each other on a personal and/or professional level. Furthermore, it would be desirable for physical communities to have an online presence in a single platform that would allow them to participate in forums and discussions, invite others to local competitions, classes and events, share content and attend online events. Furthermore, there is a need for a single e-commerce platform that allows fitness enthusiasts, merchants and vendors, gym owners, event administrators, and race directors to achieve all of this via the Internet. Finally, in order for a fitness related ecosystem to stay profitable, there is a need to develop a strategy for maintaining a constant flow of new members. With limited information technology budgets to maintain websites and social networking accounts, as well as very limited marketing, and sales budgets, this is most difficult. Thus, a common agnostic fitness, health and wellness social e-commerce platform that addresses all these problems is needed to overcome these obstacles.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention:

FIG. 1 is a block illustration of an exemplary disclosed system for the fitness, health and wellness social e-commerce platform.

FIG. 2 is a schematic illustration of an exemplary database which may be included in the disclosed system of FIG. 1,

FIG. 3 shows an exemplary flowchart of the front-end in accordance with the principles of the present invention.

FIG. 4 shows an exemplary flowchart of the back-end in accordance with the principles of the present invention.

FIG. 5 is a block illustration of an exemplary fitness, health and wellness social e-commerce platform site map.

FIG. 6 shows an exemplary overview of the e-commerce platform.

FIG. 7 is a block diagram of the distinct site within the fitness, health and wellness social e-commerce platform.

FIG. 8 is a block diagram of the virtual currency engine functionally coupled with the processor, memory and storage.

FIGS. 9A-E show an exemplary e-commerce builder tool.

FIG. 10 is an exemplary user store front.

FIG. 11 shows an exemplary checkout mechanism.

FIGS. 12A-B show exemplary communications generated when a transaction is completed.

FIGS. 13A-G show an exemplary community site of the fitness, health, and wellness social e-commerce platform.

FIGS. 14A-K show an exemplary community profile from the perspective of the administrator of the community profile of the fitness, health, and wellness social e-commerce platform.

FIGS. 15A-D illustrate a preferred embodiment for the Fit Journal feature of the fitness, health and wellness social e-commerce platform.

### SUMMARY OF THE INVENTION

One of the objectives of the fitness, health and wellness social c-commerce platform is to provide a cloud-based solution where users can search for fitness, health and wellness related activities, communities (online and offline), gatherings, clubs, gyms, instructors, products, services, locate them, research them, rate them, purchase them, attend them, and even sign up for memberships, classes or events. The fitness, health and wellness social e-commerce platform consolidates the extremely large, fragmented market of fitness, health and wellness into one portal.

Another objective of the fitness, health and wellness social e-commerce platform is to build the largest database of gyms in the world, with profiles inclusive of pictures, videos, and class schedules of over 200,000 facilities, from which the fitness health and wellness social e-commerce platform's members can use to build community.

Another objective of the fitness, health and wellness social e-commerce platform is to provide a solution that brings new members to gyms. The social network and e-commerce aspects of the fitness, health and wellness social e-commerce platform does this by turning every gym member, fitness enthusiast and health and wellness community member into a salesperson for his or her favorite fitness facilities, by way of interacting with other users, online and offline, and endorsing products, events and services on the fitness, health and wellness social e-commerce platform.

Another objective of the fitness, health and wellness social c-commerce platform is to provide an e-commerce platform that operates as a social network in which the interaction between fitness enthusiasts is what drives revenue into the e-commerce components. Sales and business development are primarily handled through the vast network of commissioned sales people in the network itself. Revenue is earned by the fitness, health and wellness platform in the form of transactional fees for every transaction completed on the platform. A portion of these revenues are shared back with the purchasers and referring parties (sales people) who had a link to the shoppable item in their feed or their store. This revenue share accumulates in the user's digital wallet on the platform that is then able to be used to purchase items themselves or redeem for cash. Revenue is also earned from merchants and service providers promoting products and services on the platform to various groups of users, traditional CPC, CPM and CPA advertising.

An e-commerce component is a mechanism that allows users to buy or sell goods or services through the management tool. A post, calendar event or digital content, such as photos or videos, is “shoppable” if it is coupled with an e-commerce component. Collectively, these may be referred to as “shoppable items”. A “feed” is a collection of posts, calendar events or digital content shown in the order that they were published. A “shoppable feed” is a feed composed of shoppable items. E-commerce components do not require a merchant account, as everyone on the platform is considered a merchant. Any user of the platform and any seller of any shoppable items must agree to platform terms and services before selling and/or redeeming.

Every user has a feed, a store, a gallery, a calendar and is part of communities where there may be items for sale. For example, User-A's feed may be an amalgamation of other users' shoppable items. User-A simply adds such an item to their store or their feed or to their calendar by clicking “Add to” button associated with each store post or shoppable feed item throughout the platform. Adding something to one's personal profile or group profile from another user's feed, store, calendar or gallery makes them the referring party (“referrer”) of that item. If another user/follower finds that item in the referrer's profile, and purchases that item (thus, becoming a “consumer”) the referrer will receive a credit in the form of a commission credited to their digital wallet, once the transaction clears.

E-commerce components are integrated throughout the site and revenues are shared with the users in the form of actual currency credited to the user account (“digital wallet”). Each user account has an associated user digital wallet where transactions made in the fitness, health and wellness social e-commerce platform will be reflected. The balance contained in a user's digital wallet is referred to as “virtual currency”. Users may use this virtual currency for transactions made in the fitness, health and wellness social e-commerce platform. A user earns or spends virtual currency balance according to whether he or she is a consumer, a referrer or a creator (i.e., originator of the item(s) for sale). Collectively, these are referred to as the categories of users. For each transaction the fitness, health and wellness social e-commerce platform will calculate the amount of virtual currency earned by the creator and the referrer, and if the consumer used virtual currency as the method of payment, the fitness, health and wellness social e-commerce platform will deduct that amount from the user's virtual currency balance.

The platform will offer a separate fitness rewards program for those wishing to receive additional discounts or referral credits on items or services for sale on the platform. These rewards can be used at checkout, converted into actual currency, or be used on a barter basis with other members to exchange products and services from each other's stores. Fitness rewards will be accumulated through interactions, goals and achievements, posted by other members, merchants or service providers. An example is “ABC Workout Month Competition” or “XYZ Gym Referral Madness March” where participants would earn reward points and virtual currency for participating and accomplishing certain objectives. These points can be converted to cash or exchanged for items on the platform.

Users can set up profiles with shoppable items as well as store fronts to sell merchandise. User profiles may also include classified advertisements where they can sell soft asset shoppable items, such as memberships, classes, services, on-line classes, and create and sell events. Referrers, for example, earn money for referring a person to a gym, class, event, or product. The virtual currency they earn may then be used as cash equivalent for additional purchases on the site. For example, at checkout the user's virtual currency value is calculated and the user can apply part or all of it to their purchase. The amount is then deducted and remaining balance of virtual currency is recalculated.

The fitness, health and wellness social e-commerce platform does not charge the user for the creation of e-commerce components. Rather, the tool's model is to provide a social commerce platform that users can use at their discretion, and the management tool takes a fee from the originator of the transaction whether it's an event manager or a gym owner, service provider or merchant. Therefore, the customer pays a flat fee with no add-ons, and the event planner or merchant pays a per-transaction fee for using the platform. Fees may vary depending on the event, membership program, class, or product.

The fitness, health and wellness social e-commerce platform shop allows vendors to sell their merchandise on store fronts. Stores may be divided into hard assets stores and soft assets stores. Hard assets stores sell merchandise such as food, apparel, products, and gear. Soft assets stores sell memberships, classes, events, digital content, and on-line content. All assets may be marketed and sold directly from the profiles. Vendors go through screening committee selection process and are monitored for quality control.

Another objective of the fitness, health and wellness social e-commerce platform is to provide a social networking site in which revenue is shared between the fitness, health and wellness social e-commerce platform and the users. In one embodiment, the fitness, health and wellness social e-commerce platform is an opt-out social network, meaning that the users are already admitted into the community of health and fitness enthusiasts, and therefore, have to opt-out rather than opt-in. Being invited into a gym's community immediately connects the user with thousands of members of that online and physical community. The opt-out model is expected to grow into a substantial network that can be monetized in a number of ways through advertisers and product placement. In another embodiment, profits are shared based on a ranking system.

Users receive revenue in a number of ways. In one embodiment, users can set up profiles with an e-commerce component as well as store fronts to sell merchandise. User profiles may also include classified advertisements where they can sell memberships, classes, services, on-line classes, and create and sell events. Users can also generate revenue in other ways such as expanding their networks to include potential customers. In addition, users can upload fitness videos or instructional videos and charge for those through the fitness, health and wellness social e-commerce platform's fitness store. Users can also generate revenue in other ways, such as by referring people to other profiles and pages, suggesting they purchase those items, memberships or classes. Users can also generate revenue by receiving a share of the advertising revenues collected by the platform for advertisements served up on their profiles or their communities (groups). For all these actions, members get virtual currency that can be cashed in or used as currency on the fitness, health and wellness social e-commerce platform.

Another objective of the fitness, health and wellness social e-commerce platform is to provide a social networking experience. In another embodiment, the fitness health and wellness social e-commerce platform provides members with a social network experience where they can, without limitation, have a user profile, read feeds, post content, share content, create groups, create events, watch photos or videos, read blogs, send messages, register for events, “like” other posts, mass invite, add location to a post, include location tags on posts and buy or sell fitness related items directly from a post or feed. Furthermore, the management tool provides integration with other existing social media platforms.

Users have to register and log-in in order to access the functionalities of the fitness, health and wellness social e-commerce platform. Registered, logged-in users are able to access all of the features of the website including signing up for memberships, classes, and events; see digital content; read blogs; comment; learn and contribute to the learning; among other things. In one embodiment, users that are not logged-in are able to access limited sections of the website. For example, they may be able to search gyms, look at public profiles, and access other limited sections of the website. When a user that has not logged-in reaches a section of the website that requires valid credentials, the website gives the user the option to login or register.

When a user logs-in, he or she lands on a dashboard that includes My Fitness, Fitness Community, and direct links to popular groups like Crossfit, Yoga, Triathlon, Football, and Extreme Sports. Once inside My Fitness, the user has the option to post, interact, make connections, find events, get advice, see who is going to which event, accept invites, and other similar functions. It should be noted that posts may be automatically posted in other social networks with the consent of the user. For example, if a user creates a post on FITMOO™, that post may automatically appear in other social networks, such as FACEBOOK®, TWITTER®, etc. It is an important aspect of this invention that posts, including those shared with other social networks, may have an e-commerce component (i.e., shoppable posts) and links back to the shoppable item(s) on the platform.

The fitness, health and wellness social e-commerce platform provides a profile editor where the user is able to manage his or her profile, see what it looks like to the outside world, look at user statistics, and manage notification settings. Users can do mass invites to invite people from other social networks and their own customer relationship management databases (CRM's) via email, and manage their shoppables from an e-commerce builder tool.

The fitness, health and wellness social e-commerce platform also provides a search tool that categorizes search results on topics, words, profiles, groups, events or items. The search tool may be powered by any commercially available search engine.

Another objective of the fitness, health and wellness social e-commerce platform is to provide a calendar that includes a user's events, as well as all the events the user selects from the calendars of other users. In one embodiment, the calendar shows all user events, all the events the user has brought from another user's calendar, and every event from calendars and profiles a user has favorited. The calendar may be tightly integrated into other fitness related websites and therefore, events from other websites may show there as well. Furthermore, the tool includes an editing functionality that allows the user to edit his or her preferences with respect to the integrated fitness related websites in order to specify the type of events the user is interested in attending and/or the geographic area where the user is most interested in attending. The user may also filter events on his or her calendar such that he or she sees only those events that match the filter. These may include filtering the calendar items by its type, time range, geographical location, followers, and others.

In one embodiment, events can be searched and detailed events can be created using the event registration tool as well as the user's post box. These created events may include an invite tool allowing users to invite other users, communities or groups of people to that event. Invited users do not have to be registered on the fitness, health and wellness social e-commerce platform to be invited to an event created on the platform. In another embodiment, events may be created in one of two ways. First, the user can create an event and post it to an update. In addition, events may be created in the calendar where a more detailed description of the event is included with specific information relating to the event such as location, number of spaces available, photo uploads, and whether invitees can invite other users. An important aspect of the invention is that calendar events can be made shoppable. The fitness, health and wellness social e-commerce platform will handle the transaction for the user and will pay the creator of the shoppable event after taking a small fee. The fee the management tool collects will be shared with the creator of the event, the purchaser in the form of a rebate, and the referrer, if any.

The fitness, health and wellness social e-commerce platform has the ability to consolidate all those calendars that a user is following. Users can dynamically filter the social calendar by person, group, location, time and entry-type. Users can sign up for events from the social calendar, and can synch multiple consolidated fitness calendars with mobile calendar. Another objective of the fitness, health and wellness social e-commerce platform is to allow users to create groups. The fitness, health and wellness social e-commerce platform's “groups” or “communities” is another powerful functionality. Groups have threads and posts, their own calendars and stores, and the ability to manage the group through a robust administration tool, including the ability promote administrators, ban members and interact with the group in several ways.

Another significant aspect of the fitness, health and wellness social e-commerce platform is that users can create communities around common interests and activities, and invite members of the social e-commerce platform to join their community. Owners of communities can create event schedules, storefronts and communal feeds, so members can socialize, purchase and interact. Owners can add shoppable items to the communities, such as products, services, events and memberships. All communities are searchable on the fitness, health and wellness social e-commerce platform, unless privacy settings specify otherwise. Events or classes that are posted to the community's calendar are inherently social, in that each event is accompanied by its own communal feed, and any activity around that event or class, such as signing up, is published to other members of the group.

Another significant aspect of the interactions between fitness enthusiasts is the fitness, health and wellness social e-commerce platform's photos and videos. Users are encouraged to post photos and videos of workouts, finish lines, events, contests, competitions, and even weight loss successes (before and after). The fitness, health and wellness social e-commerce platform allows users to upload unlimited photos and post unlimited links to videos hosted by other video hosting sites. Any user may create albums, add pictures from other profiles to their own albums, and also repost these pictures and videos to their own threads, sharing them with their own network and groups. Photos or videos of events or products can be shoppable, allowing another user to click on the photo or video post and be directed directly to a product or service in a user's store, which can then be purchased.

Another important aspect of the fitness, health and wellness social e-commerce platform is that fitness videos may be shoppable. Shoppable videos are uploaded to a fitness-class video store where users are able to buy, rent, or subscribe to fitness-related videos. The fitness-class rental store offers access to uploaded videos using four distinct methods. Videos may be “Purchased” providing the user a link to download and store the video permanently. “On-demand” videos may also be rented and viewed at any time. In addition, the tool may offer a subscription model for unlimited “On-demand” class rentals and subscriptions to a particular instructors' content. The subscription model allows a user to view as many of the fitness, health and wellness social e-commerce platform's streams as he or she wishes, as many times per day. Within the monthly subscription model, royalties will be shared with content providers based on the total number views of their content as a percentage of the total number of views across the platform. Special events may also be offered “Live” at fixed times.

The fitness, health and wellness social e-commerce platform also provides “Streamed” access through a TV application and YOUTUBE® where videos are constantly streaming between 10-20 videos every 15 minutes. The entire schedule of streamed events is available on through the fitness, health and wellness social e-commerce platform calendar. “Streamed” content from the fitness program tool TV and YOUTUBE® can be paused for up to one hour. Revenues of the “On-demand,” “Live,” “Streamed,” and “Purchased” videos are shared with the owner of the videos.

Another objective of the fitness, health and wellness social e-commerce platform is to provide a workout tracker where users can post workouts that can be shared with other users or with non-registered users via a hyperlink.

Another objective of the health and wellness social e-commerce platform is to provide a feature known as “Fit Journal” which allows a user to develop his or her “fitness resume” by recording their fitness and wellness journey. If a user enables the Fit Journal feature on their profile, the feature records every class and event they have attended, every workout they have done, every competition they have attended, every meal they have consumed, and every goal they have achieved. Pictures, videos, texts and chats are all recorded, chronologically to produce a fitness journey that can be reviewed, printed, and shared with friends, family, followers, coaches and instructors.

Another objective of the fitness, health and wellness social e-commerce platform is to provide a “Professional” section where registered users can subscribe to and gain access to an exclusive club of professional athletes from selected sports. Registered users pay a nominal fee to access the “Pro Site”. The fitness program shares this income from the “Pro Site” with the pro athletes. Pro athletes need to be admitted by a screening committee. Collegiate athletes may also be admitted into the professional section.

Besides memberships, the fitness, health and wellness social e-commerce platform offers a dedicated Community and Resources portal where users can post, share, and create “groups” or “communities”. In one embodiment users and fitness professionals are able to engage in “eCoaching”. eCoaching refers to distance coaching by creating a private group or community on the fitness, health and wellness social e-commerce platform between a coach or instructor and one or more individuals. Workouts and nutritional entries are contained in the group calendar and group feed. Members of the private group are able to: get feedback from each member of the private group on how they are progressing; update workouts and nutrition; set fitness goals; sell products and services from the community store; encourage, interact, share and sell products to members; and allow members of the group to sell items from the community store by putting those items in their store.

The site also offers the option to users to enable an existing profile to be part of a dating database where the user can meet friends in their geographical area. The users may also search through profiles that have dating enabled to find a match based on other traits as well. Similarly, a user may enable his or her profile to be part of a jobs database. The jobs database is searchable by employers looking for trainers, sales people, experts, and users with other qualifications.

Another objective of the fitness, health and wellness social e-commerce platform is to provide a platform in which the owners of the fitness, health and wellness social e-commerce platform share statistics, behavioral data and consumer analytics with the user to help the user create larger networks and increase their earning potential.

In another embodiment, the fitness, health and wellness social e-commerce platform sends email triggers to market itself to users, merchants and service providers in the fitness health and wellness market. Such email triggers include but are not limited to a sign-up, purchase or registration by a user to a competitive merchant, service provider or gym in the same geographic area or an email to all merchants, service providers or gyms if a certain topic has been searched by a user on the platform.

### DETAILED DESCRIPTION OF THE INVENTION

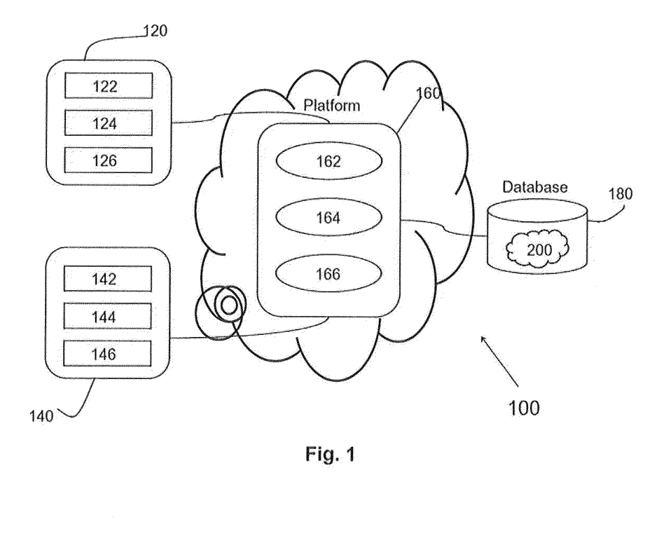

FIG. 1 illustrates a fitness, health and wellness social e-commerce platform system 100. System 100 may include an input module 120, an output module 140, and a computing platform 160. Computing platform 160 may include or may be otherwise operatively coupled to a database 180, which may be stored in a memory 200. Database 180 may include more than one database or another type of electronic repository. Computing platform 160 may include the software functionality and hardware capabilities to implement fitness, health and wellness social e-commerce platform features through input module 120 and access, read, and write to database 180.

The results of data received from a user may be provided as output from computing platform 160 to output module 140 for printed display, viewing, and/or further communication to other system devices. Such output may include, for example, printout of a screenshot corresponding to an individual fitness account, to a selection of a group account or to any type of report involving a user(s) fitness program.

In accordance to one embodiment of the fitness, health and wellness social e-commerce platform, an e-commerce builder tool 600 is provided where the user can create and post shoppable items to their profiles, groups, community and resources, and to other social networks 620. The e-commerce builder tool 600 allows a user to sell hard assets 610, as well as soft assets 611, 612. The user can also offer or list items for sale on a store front which will be part of the platform An e-commerce component is a mechanism that allows users to buy or sell goods or services through the fitness, health and wellness social e-commerce platform 600. A post, calendar event, or digital content, such as photos or videos, is deemed shoppable if it is coupled with an e-commerce component. A feed is a collection of posts, calendar events or digital content shown in the order that they were published. A shoppable feed is a feed composed of shoppables.

In a preferred embodiment of the present disclosure, the output module 140 may render files using a display. That is, in a preferred embodiment of the present disclosure, a computing platform 160 may be configured to display fitness program management tool functionalities upon selecting or activating the output module 140, which may include a monitor, screen, projector or similar panel depicting the desired content.

It is also contemplated, however, that the output module 140 may further provide technical data such as performance estimates and reports pertaining to individual or group performance regarding the fitness program. Data provided by output module 140 may additionally or alternatively include metadata for the content, which a user may desire to obtain from the fitness, health and wellness social e-commerce platform for his or her reference. Such metadata may include information about a user, gym, instructor; demographic data; commerce analytics; consumer analytics; behavioral data; or even technical data, such as a user's name or nickname, email account, platform identifier, and/or operating system (e.g., Android, iOS, etc.) used by the computing platform 160. Additionally or alternatively, the metadata may relate to the file itself, such as to include information on the date and time the file was created, accessed, modified, or edited and location specific information. Output from computing platform 160 can also be provided to database 180, which may be utilized as storage device for files and fitness-related data pertaining to a user. This form of output may be stored in a folder corresponding to the user's account or under a predetermined directory folder.

In the embodiment of FIG. 1, computing platform 160 may include a cloud computing provider, a standalone web-server, a personal computer (PC), a mainframe computer, or a laptop computer configured to perform various functions and operations. That is, computing platform 160 may include software functionality and hardware capabilities to implement fitness, health and wellness social e-commerce platform features according to an embodiment of the disclosure. Computing platform 160 may be implemented, for example, by a general purpose apparatus selectively activated or configured by software stored in memory of the apparatus, or may be a specially constructed computing platform for carrying out the features and operations of the fitness, health and wellness social e-commerce platform 100. It is contemplated, that the computing platform 160 may be accessible via a web browser from any device without the need to download and install an application on every device in which the user desires to experience the fitness program management features in the manner enabled by the present disclosure. That is, the fitness, health and wellness social e-commerce platform features of the present disclosure reside in the cloud and thus are executable over a web browser or may reside locally, such as in a smart phone application downloaded from an application market or preloaded by the smart phone's manufacturer. However, the fitness, health and wellness social e-commerce platform may be accessible through a computing platform 160 having locally executed software to perform the fitness, health and wellness social e-commerce platform features of the present disclosure.

In order to perform these tasks, computing platform 160 may also be implemented or provided with a wide variety of components or subsystems including, for example, one or more of the following: a processor 162, a co-processor 164, a register 166, and/or other data processing devices and subsystems. Computing platform 160 may also communicate or transfer user files and fitness-related data as well as feedback provided by the user or third parties via input module 120 and/or output module 140 through the use of wired connections, wireless connections or other means of communication, as depicted in FIG. 1.

In an exemplary embodiment, a security layer such as firewall may prevent access to the computer platform 160 by unauthorized external entities. It is further contemplated that computing platform 160 may use techniques such as data encryption and/or require user authentication, such as password verification, biometrics, pattern recognition, speech recognition or similar means, in order to prevent unauthorized users from gaining access to sensitive information, files, and fitness, health and wellness social e-commerce platform preferences associated with a particular individual.

It is further contemplated that communication between computing platform 160 and input and output modules 120, 140 can be achieved through the use of a network architecture (not shown). In such an embodiment, the network architecture may include, alone or in any suitable combination, a telephone-based network (such as a PBX or POTS), a local area network (LAN/WLAN), a wide area network (WAN), a VPN, a dedicated intranet, and/or the Internet. Further, the network architecture may include any suitable combination of wired and/or wireless components and systems necessary in order to carry out the present disclosure. By using dedicated communication links or a shared network architecture, computing platform 160 may be located in the same location or at a location geographically remote from input and/or output modules 120, 140.

Input module 120 may include a wide variety of devices to receive and/or provide the data as input to computing platform 160. As illustrated in FIG. 1, input module 120 may include an input device 122, a storage device 124, and/or a network interface 126. Input device 122 may include a keyboard, mouse, touch screen, stylus, touchpad, disk drive, video camera, magnetic card reader, or any other suitable input device for communicating data to computing platform 160.

Memory 200 may be implemented with various forms of memory or storage devices, such as read-only memory (ROM) devices and random access memory (RAM) devices. Storage device 124 may include a memory tape, disk drive, a flash memory card, an SD card or a microSD card for reading and providing data (including video files) as input to computing platform 160. Network interface 126 may receive data over a network (such as a LAN, a WAN, a mobile network, such as EDVO, 3G, 4G, GSM, an intranet or the Internet) and provide the same data as input to computing platform 160. For example, network interface 126 may be selectively connected or connectable to a public or private database for purposes of receiving information about one or more users, user files, video clips and other fitness-related data from computing platform 160.

Output module 140 may include a display 142, a printer device 144, and/or a network interface 146 for receiving the information provided as output from computing platform 160. As indicated above, the output module 140 from computing platform 160 may include a display showing fitness, health and wellness social e-commerce platform s in the manner described herein. The output from computing platform 160 may be displayed or viewed through display 142 (such as a CRT, LCD, CSTN, TFT, TFD, OLED, capacitive, resistive, AMOLED, super AMOLED, haptic/tactile, Gorilla glass or Retina type) and printer device 144. Network interface 146 may also facilitate the communication of the output from computing platform 160 over a network (such as a LAN, a WAN, a mobile network, such as BDYO, 3G, 4G, GSM, LTE an intranet or the Internet) to remote locations for debugging, reviewing or providing backup.

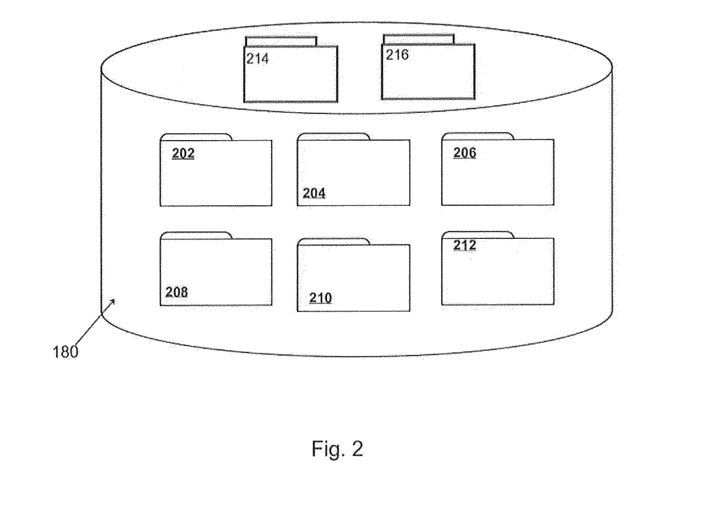

User files and fitness-related information associated to gyms, individual users or group of users may be stored in memory 200 of database 180. FIG. 2 illustrates one embodiment of database 180, which may include information about one or more users, user files, and fitness-related data. Database 180 may also include data relevant to gyms, the target population of users, content generators (i.e., trainers and gyms), content uploaders as a whole and/or to select segments of the target population. Database 180 may further include demographic data, gym attendance, browsing history, shopping habits, web searches, most visited web sites, and other fitness-related behavioral information in order to create and/or edit the directory structure stored therein. Additionally or alternatively, the database 180 may include a file structure which is built and updated based on the information and/or files shared by a particular user or group in a given social media application. Lastly, it is contemplated that an individual file entity 212 may be created and maintained according to each specific user, including both individuals as well as businesses (such as gyms or health stores).

FIG. 2 illustrates an exemplary embodiment for the database 180. Nonetheless, it is contemplated, that the file structure of database 180 may be dynamically created, organized, and/or maintained based on either information pertaining to the user (or group of users) or to the user files (or group of files). Database 180 may include additional information regarding a user's Posts 202, Calendar 204, Blogs 206, Groups 208, Connections 210, Favorites 212, Workout Tracker 214, and/or My Fitness Store 216. Nonetheless, it is contemplated that said such user information may be shown, edited or deleted, depending the user's selections, feedback detected, and/or marketing strategies implemented by the system 100.

Database 180 may further include information pertaining the User's Fitness Community. Such information may include a User's Profile, Gym Searches, Online Classes, and Class Searches, and User access information,

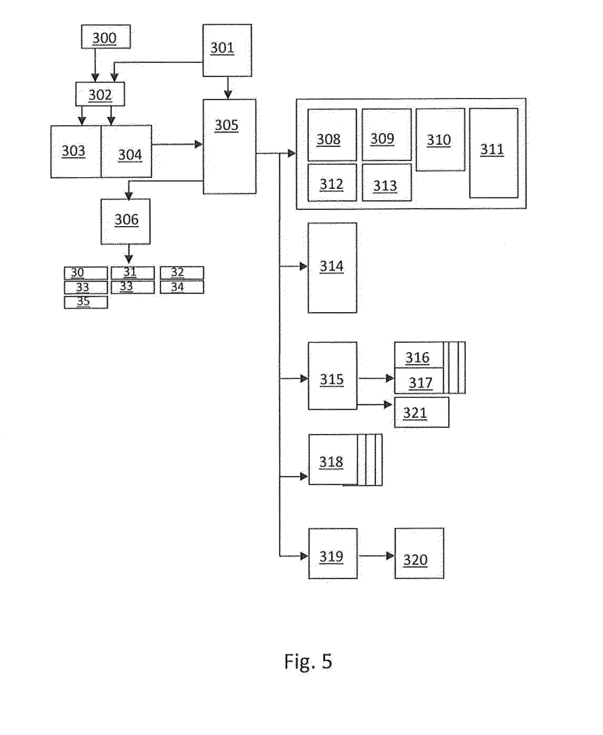

FIG. 5 is directed to the exemplary flowchart of the front-end for the fitness, health and wellness social e-commerce platform system 100. An input module 120 interacts with the fitness, health and wellness social c-commerce platform system 100 by visiting the system's web site comprising a web address. The web address might be located by actually searching 301 for the fitness, health and wellness social e-commerce platform system 100. Once the user accesses the web browser general information is displayed or provided. For example, a user is capable to get information about the system 100, benefits, testimonials and other information that encourages user to use the fitness, health and wellness social e-commerce platform system 100. Once at the initial web page the user may register or log-in. If the user selects to register, the system 100 requests user's information in order to complete or create a user's profile. For example, the user is requested to selects if he/she is an individual or a service provider 302. If the user selects to be an individual 303 the information requested by the system comprises information regarding social networks, more particularly social network applications belonging to the user, in such way that the user's social network is link to the user's profile. Further, information such as specific topics, categories and the option to join groups inside the system 100 may be requested. If the user selects to be a Service Provider 304 the information requested by the system 100 comprises the type of services provided by the user, tags and more. After the User's profile is completed the user may log into the system 100 and use all the features provided by the fitness, health and wellness social e-commerce platform system 100 such as the calendar, profile, searching for groups of particular interest, group listening, discover, see posts, comment on posts, like posts and others 305.

In accordance with one exemplary frontend flowchart, if a user selects to perform a search the system provide several search results 306. A filter or algorithm may be employed to complete a more relevant search. After the search the user might want to access each result in details 307-313. The detailed page may include information regarding links for events, Gym, Workout, group, class, person, nutrition and more.

In accordance with one exemplary front-end flowchart, if a user selects the profile feature several options are provided. Some of the profile feature options may comprise: an access/link configured to view and edit user's profile 308; an access/link configured to upload, view and manage images and videos 309; an access/link configured to create, visit, follow, unfollow groups 310; an access/link configured to visit a virtual store to shop memberships, classes, events, apps, products and services that other users are selling 313; an access/link configured to a calendar for adding, creating or deleting events, workouts and classes. Further, browse others users calendars 311; and an access/link configured to view events, classes, nutritional entries, workouts, products, friends, pictures that the user added to his profile 312.

In accordance with one exemplary frontend flowchart, if a user selects the calendar 314 he/she is able to create, delete, add, browse and view details of events, workouts or classes. In accordance with one exemplary frontend flowchart, if a user selects the group listing 315 he/she is able to view all the groups the user is part of or created. User may see public groups 316 and private groups 317. Also he/she is able to search among groups, follow or unfollow groups. The user can further create a new group using a user interface type that presents a sequence of instructions that lead the user to create said group. In accordance with one exemplary frontend flowchart, if a user selects or click on a post for details he/she may see text, photos, events nutrition, workouts and class related to said post.

In accordance with one exemplary frontend flowchart, if a user selects to discover 319 he/she is able to search for the location of a class, event, group, gym, trainer and workout. The results could be over-layed on a virtual map at the input module 120.

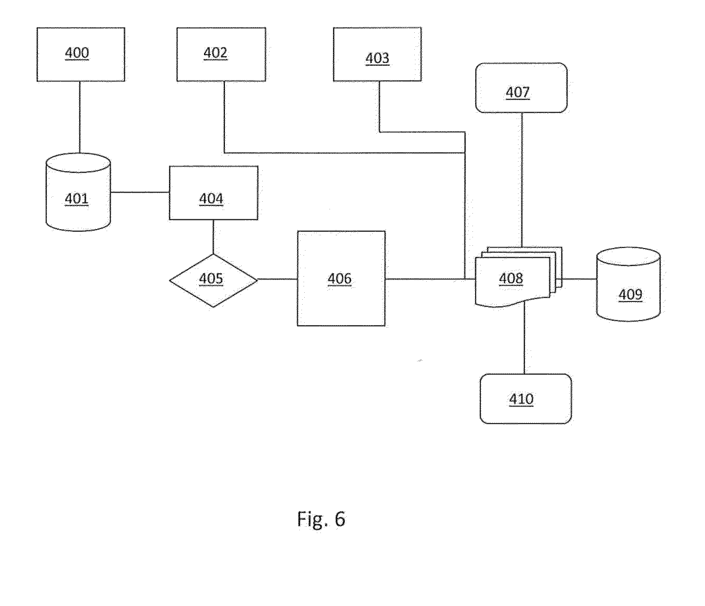

FIG. 6 is directed to the exemplary block diagram showing general overview of the e-commerce platform for the fitness, health and wellness social e-commerce platform system 100. First the user search for a product or shoppable feed, wherein said product or shoppable feed is stored at the system database 401. Once the product is selected by the user several details related to said product are provided 404 to user. The detail may include price, warranties, material, service, reviews from other users and more. Further user select to buy said product 405 presents a sequence of instructions that lead the user to complete the procedure. At least one of the instructions completes a checkout form or process which is forwarded to the e-commerce platform 408. The e-commerce platform 408, which is describe in more detail below, is further configured to manage and process the payment 410, provide confirmation email to user 403, send email to store owner 402, shipping 407 and store information.

In accordance with one exemplary embodiment, the fitness, health and wellness social e-commerce platform's members will be able to interact with other members in a social network environment. Here members will be able to, among other things, see digital content, read blogs, publish content and comment on existing content. Furthermore, members will be able to enable their profiles to be part of a dating database and/or a fitness job profile database.

In accordance with one exemplary embodiment, the fitness, health and wellness social e-commerce platform will have an interface in which members will have the option to post, interact, make connection, make goals, find groups, share calendars, track their workouts, track other workouts, find events, get advice, see who is going to an event, accept invites, among other activities.

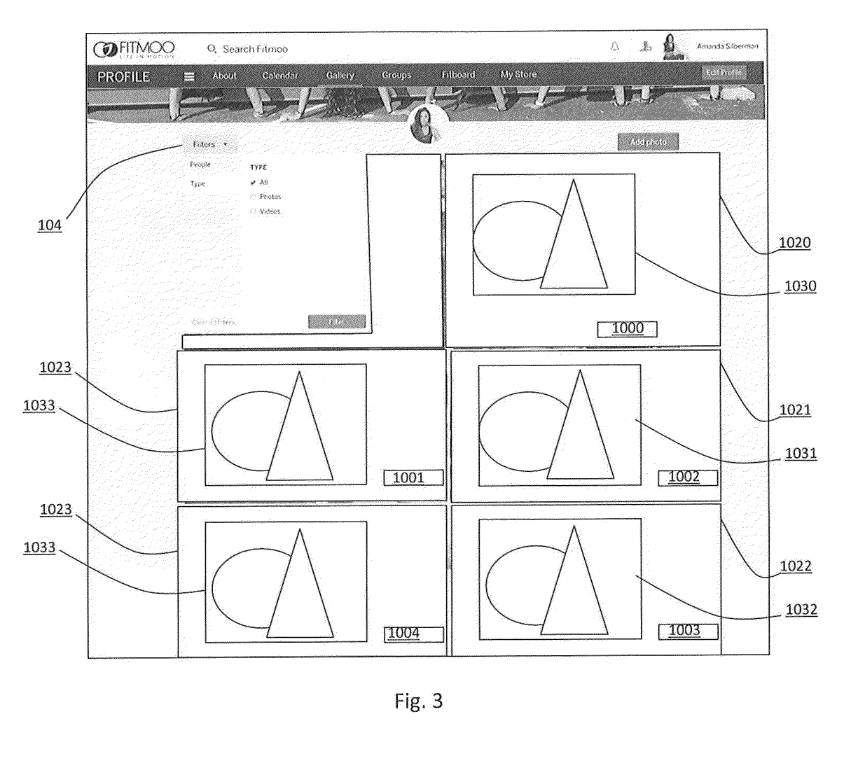

FIG. 3 illustrates a preferred embodiment for the user profiles of the fitness, health and wellness social e-commerce platform. In accordance to this preferred embodiment, a user profile contains a feed that is made up of posts from favorite users and users that are connected to the owner of the profile. Containers 1020, 1021, 1022, 1023 and 1024 are containers within the profile webpage. Said containers 1020, 1021, 1022, 1023 and 1024 may include content from posts, blog entries, pictures, videos, shoppable items, and other kinds of user-generated content. The content of the containers is referred to in FIG. 3 as 1000, 1001, 1002, 1003 and 1004. Said content may include pictures and/or videos 1030, 1031, 1032, 1033, and 1034 related to the content. Generally, the user profile shows all of the most recent user-generated content from the network of the owner of the profile. However, a filter mechanism 104 may allow a user to filter and show only the content that matches the user-provided criteria. For example, the user may choose to show only videos or photos. The user may also choose to show content generated only by particular users or groups. Said filter mechanism 104 allows the user to show all of the available content by clicking on a “Clear all filters” link.

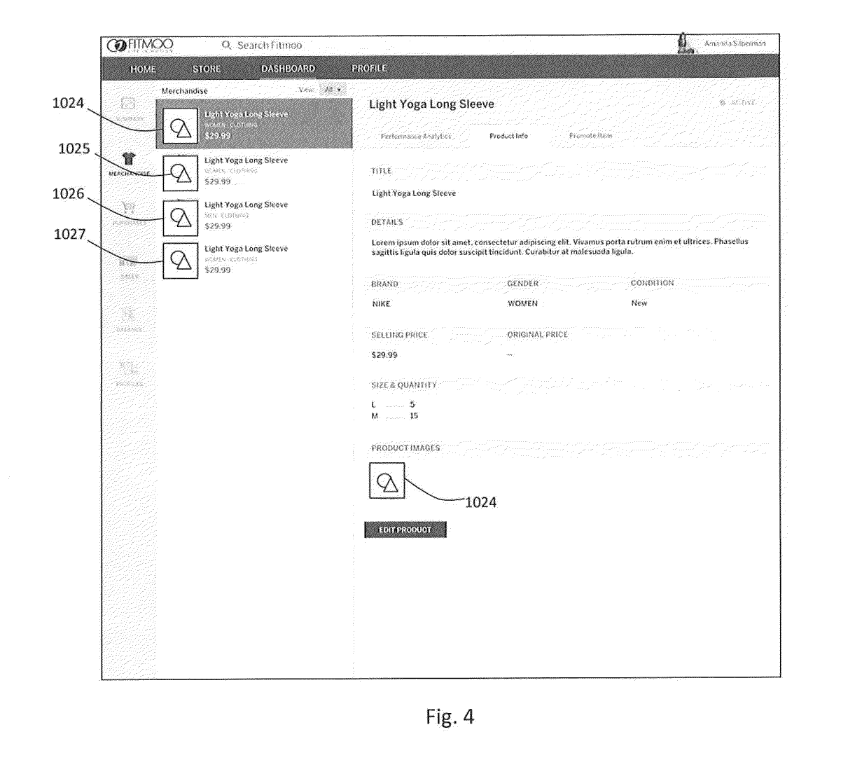

FIG. 4 illustrates a preferred embodiment for the fitness, health and wellness social e-commerce platform. In accordance to this preferred embodiment, a user is able to view all the shoppable items 1024, 1025, 1026 and 1027 associated with his or her profile in the merchandise section of the dashboard. Inside this dashboard the user may view and edit the details of the shoppable item, performance analytics, and promote said item. The dashboard also shows other aspects of the user profiles such as a summary, purchases, sales, balance and information about the profile itself (not shown in the figure).

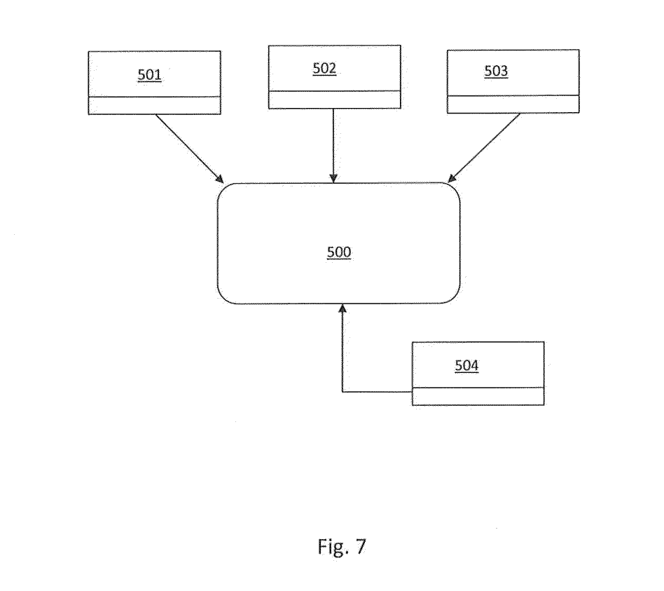

FIG. 7 illustrates a preferred embodiment for the fitness, health and wellness social e-commerce platform. In accordance to this preferred embodiment, the fitness, health and wellness social e-commerce platform 500 comprises various distinct sites with different functionalities where each of those sites is enabled for a user when he or she requests access to said sites by enabling his or her profile and adding detailed information necessary for those sites. Examples include a jobs site 501, a dating site 502, a community and resources site 503, and a professional site 504. All of those sites are enabled to integrate with each other such that the transition from one to the other is seamless from the point of view of the user. However, each of those sites may include their own computing platform 160 and database 180 in order to service user's requests.

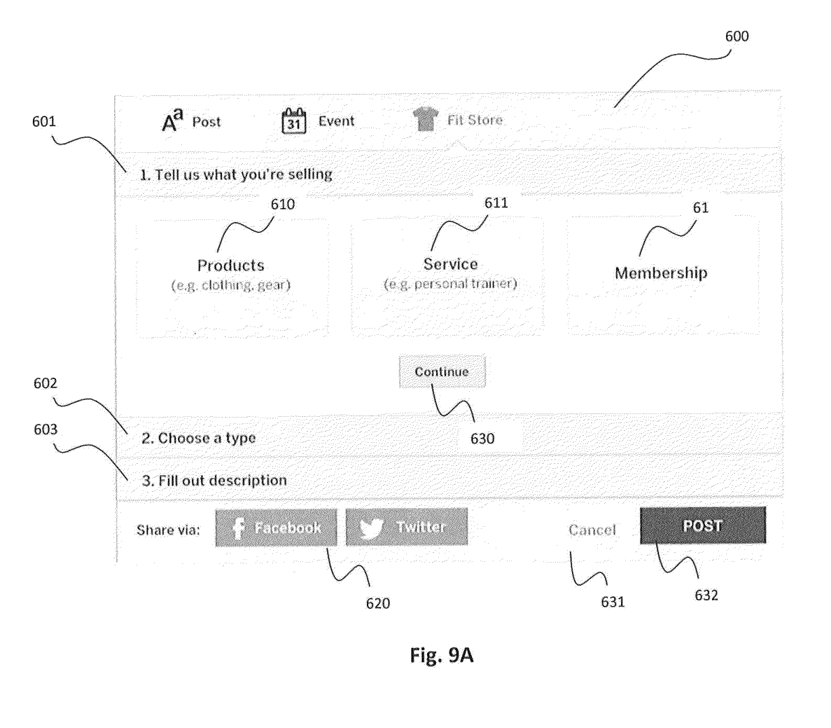

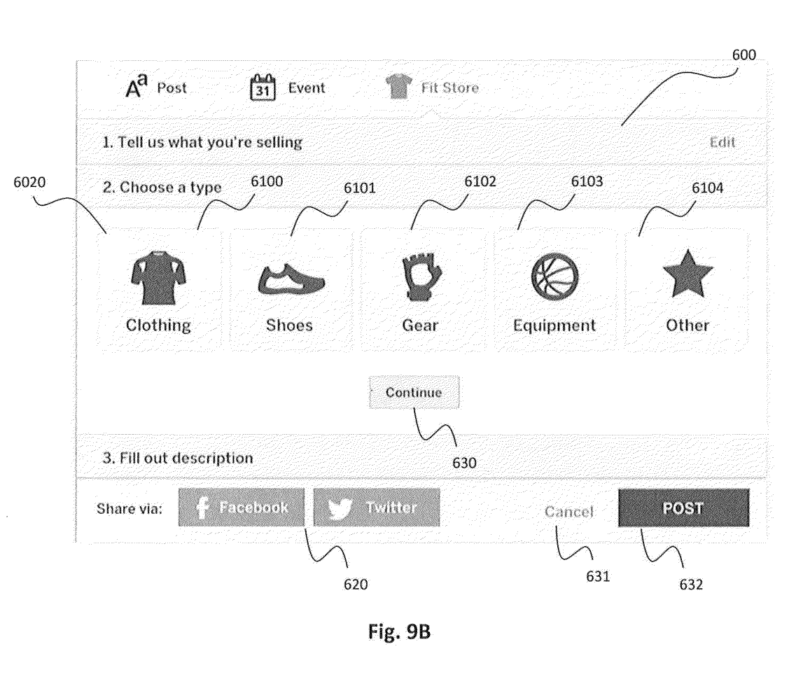

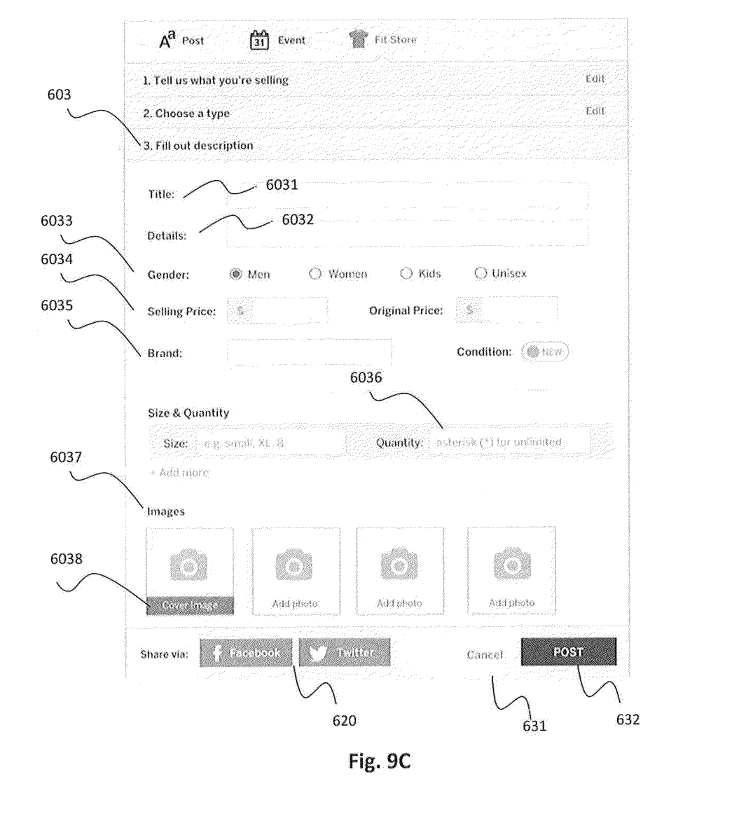

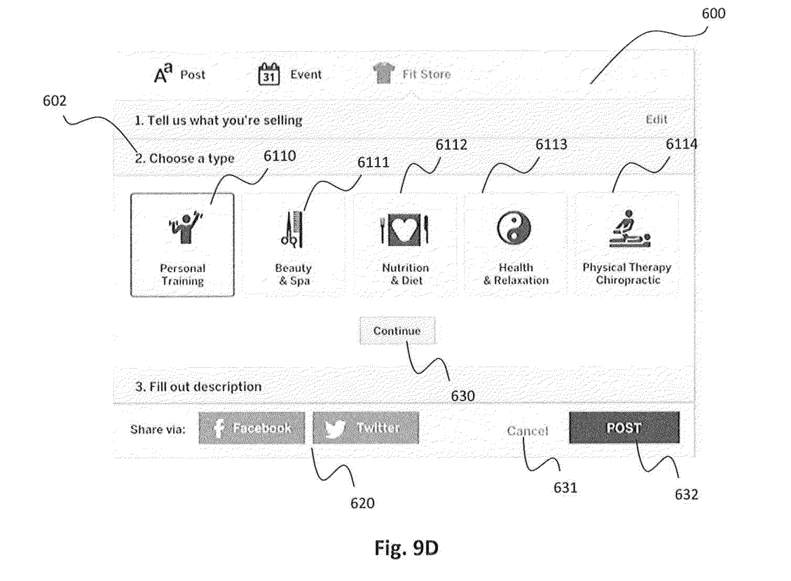

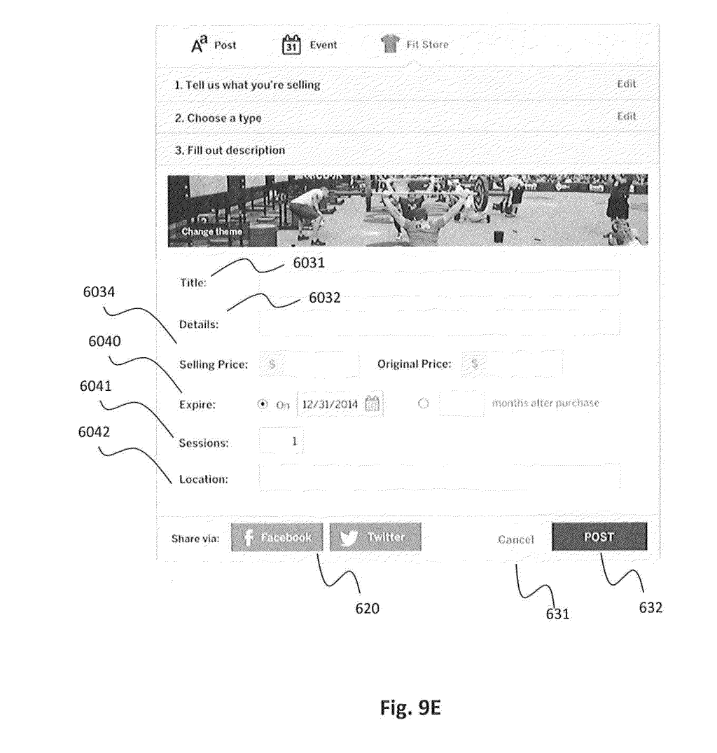

FIGS. 9A, 9B, 9C, 9D, 9E illustrate a preferred embodiment for the e-commerce builder tool 600. In accordance to this preferred embodiment, the fitness, health and wellness social e-commerce platform comprises an e-commerce builder tool 600 used to create shoppable items. The e-commerce builder tool 600 includes three panes 601, 602, 603 where the user will specify the category of asset 610, 611, 612 he or she is selling, as well as detailed information about said asset. In this particular embodiment the categories of assets are products 610, services 611, and memberships 612. Products 610 are generally hard assets while services 611 and memberships 612 are generally soft assets. Once the user has selected the type of asset 611, 612, 613 he or she is selling, the user may click on the “Continue” button 630.

In the example of FIG. 9B, the user chose the products 610 as the category of asset he or she would like to sell. Afterwards, the user clicked on the “Continue” button 630. This causes the second pane 602 to appear where the user will select the type of product 610. Types of products 610 include clothing 6100, shoes 6101, gear 6102, equipment 6103, and other 6104. Again the user chooses one type of asset and clicks on the “Continue” button 630. This causes the third pane 603, shown on FIG. 9C, to appear where the user may enter detailed information about the asset including its title 6031, details 6032, gender 6033, selling price 6034, brand 6035, size and quantity 6036, and images 6037 and original Manufacturer SKU. The user may also choose the cover image 6038 that will show on the shoppable feed.

In the example of FIG. 9D, the user chose the service 611 as the category of asset he or she would like to sell. After choosing the category of asset, the user clicked on the “Continue” button 630. This causes the second pane 602 to appear where the user will select the type of service 611. Types of services 611 include personal training 6110, beauty and spa 6111, nutrition and diet 6112, health and recreation 6113, and physical therapy chiropractic 6114. Again the user chooses one type of asset and clicks on the “Continue” button 630. This causes the third pane 603, shown on FIG. 9E, to appear where the user may enter detailed information about the asset including its title 6031, details 6032, selling price 6034, when the service will expire 6040, the number of sessions 6041, and the location 6042.

The user may click on the Post button 632 at any moment which causes the shoppable item to be stored in the shoppable item data store 712. This means that the user controls how detailed he or she wants the shoppable item to be. The user may also cancel the shoppable item at any time before posting by clicking on the “Cancel” button 631 or mark it out-of-stock or discontinued if inventory applies to such an item. The e-commerce builder tool 600 is tightly integrated with social networks such that the user may also share the shoppable item via other social networks by clicking on the share buttons 620.

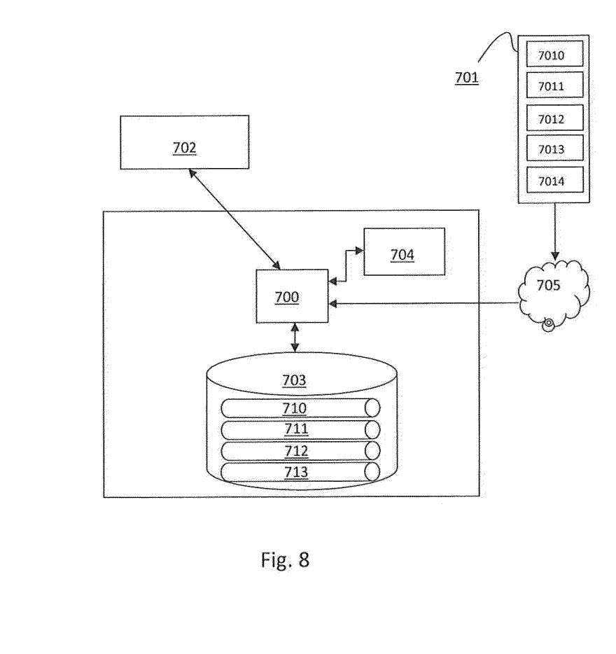

FIG. 8 illustrates a preferred embodiment for the e-commerce platform. In accordance to this preferred embodiment, the fitness, health and wellness social e-commerce platform comprises an e-commerce platform including a processor 700, a virtual currency engine 702, a storage 703, a memory 704, and a network 705. The storage 703 contains a plurality of data stores associated with different aspects of the invention. For example, a user profile data store 710 contains information about a plurality of users, a virtual currency data store 711 contains a balance of virtual currency for each of the plurality of users, a shoppable item data store 712 contains information about shoppable items, and a transaction data store 713 contains a plurality of transactions, wherein each transaction contains information about a shoppable item 7010, a plurality of categories of users 7011, 7012, 7013 associated with the shoppable item and a method of payment 7014. The categories of users include the creator of the shoppable item 7011, the referrers of the shoppable item 7012, if any, and the consumer of the shoppable item 7013.

When a user buys or rents a shoppable item, the system generates a transaction 701. A virtual currency engine 702 responds to each transaction 701 and recalculates for each user in the transaction 701 the balance of virtual currency in the virtual currency data store 711 according to the plurality of categories of users and the method of payment.

Once a consumer of the shoppable item buys or rents the shoppable item, a transaction 701 is generated by the fitness, health and wellness social e-commerce platform and the virtual currency engine 702 responds to said transaction 701. The generated transaction 701 contains information about the shoppable item such as the creator 7011, the referrers 7012, if any, the consumer 7013, and the method of payment 7014. The virtual currency engine 702 uses this information to adjust the balance for each of the categories of users, namely, the creator, the consumer, and the referrers, if any. For example, the creator 7011 and the referrer 7012, if any, receive the revenue generated from the sale or rental of the shoppable item. That is to say that a determined amount of virtual currency will be added to the balance of virtual currency for the creator 7011 and the referrer 7012, if any. On the other hand, if the consumer 7013 used virtual currency as the method of payment 7014, the virtual currency engine 702 verifies that the amount of virtual currency is indeed available and, if it is, deducts said amount from the balance of virtual currency of the consumer 7013 of the shoppable item. After the virtual currency engine 702 has determined the new balance for the plurality of categories of users 7011, 7012, 7013, the virtual currency engine 702 stores said new balance in the virtual currency data store 711.

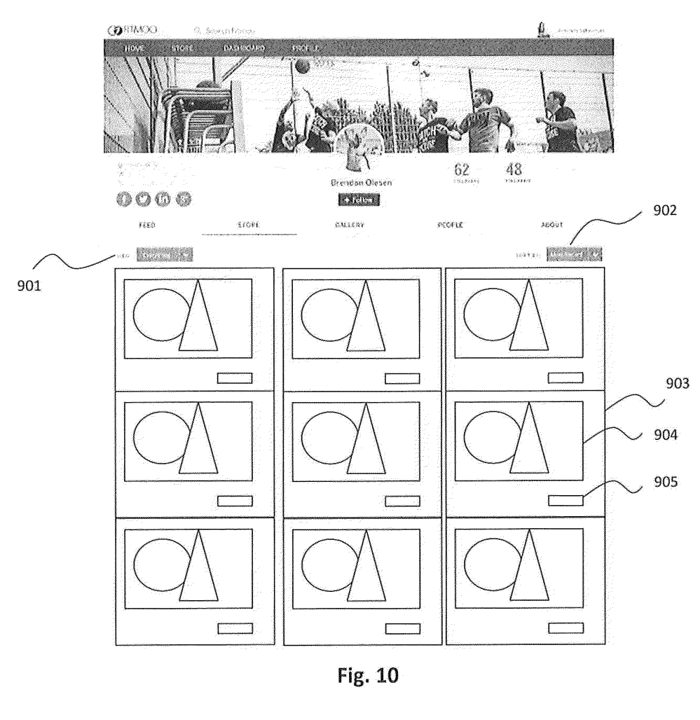

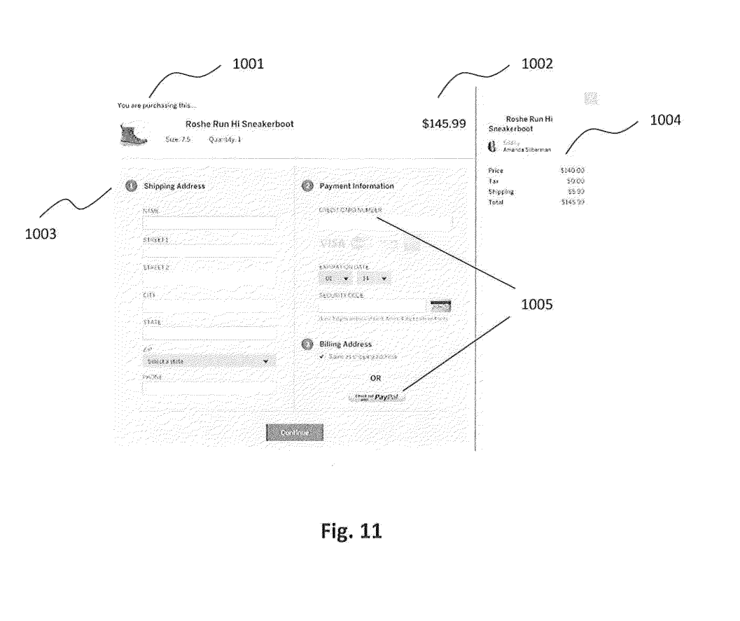

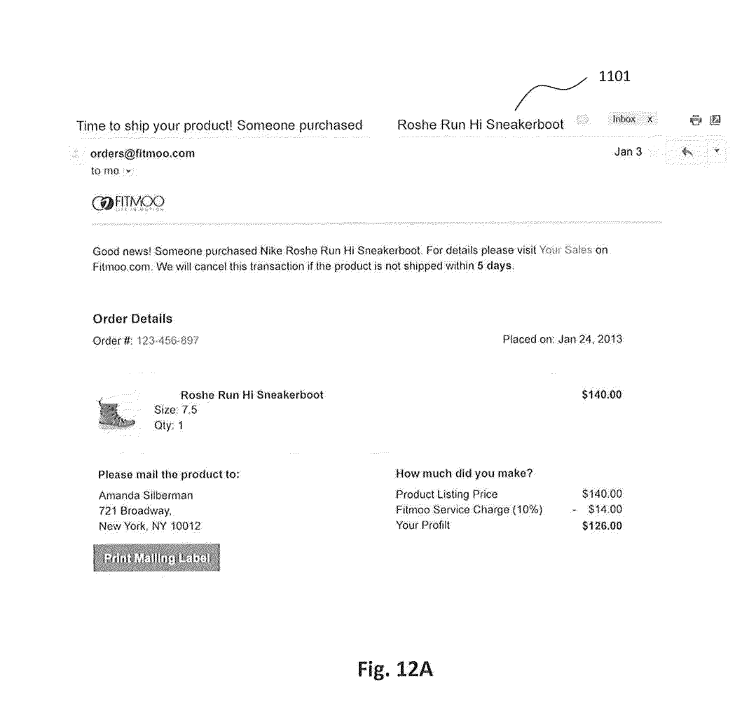

FIG. 10 illustrates a preferred embodiment for the fitness, health and wellness social e-commerce platform. In accordance to this preferred embodiment, the fitness, health and wellness social e-commerce platform comprises a store front associated to a user's profile that shows all of the shoppable items in said user's profile. Shoppable items 903 are shown within a container wherein said container shows a description of the shoppable item, such as a name or short description of the product, an “ADD TO CART” or “BUY” button and optionally an overlay detail window (not shown in figure), a picture of the shoppable item 904 with an embedded hyperlink to go to the detail page for this product, and the price (with any applicable discount information) of the shoppable item 905. Users are able to sort shoppable items using the “sort by” button 902. Users may also filter the shoppable items using the provided filter mechanism 901. FIG. 11 illustrates a preferred embodiment where the user has selected to buy a shoppable item. Information 1001 about the shoppable item, is shown at the top of the screen including the price 1002 of the shoppable item. A summary 1004 of the shoppable item is also shown at the right of screen. The consumer of the shoppable item has to input his or her shipping address 1003, and method of payment 1005. The user may also pay using an external merchant/payment processor such as PAYPAL®.

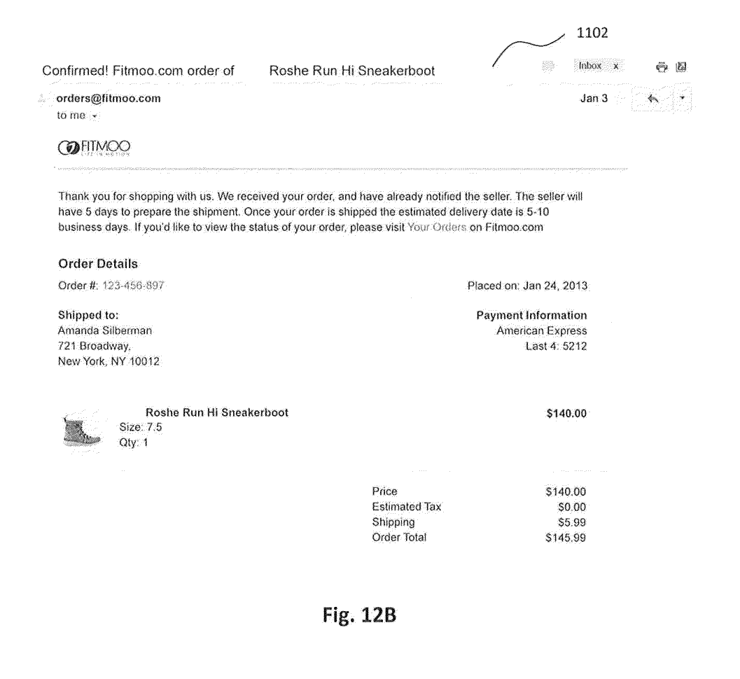

FIGS. 12A and 12B illustrate a preferred embodiment where the consumer of the shoppable item has completed all necessary steps to buy the shoppable item. In the example of FIG. 12A, the creator of the shoppable item receives an email communication 1101 from the system with the shipping information of the consumer of the shoppable item. At this point the amount owed to the creator of the shoppable item has already been deposited in his virtual currency account. Similarly, the consumer of the shoppable item receives a confirmation email 1102 with information about the payment and the shoppable item. At this point, the consumer has already paid for the shoppable item.

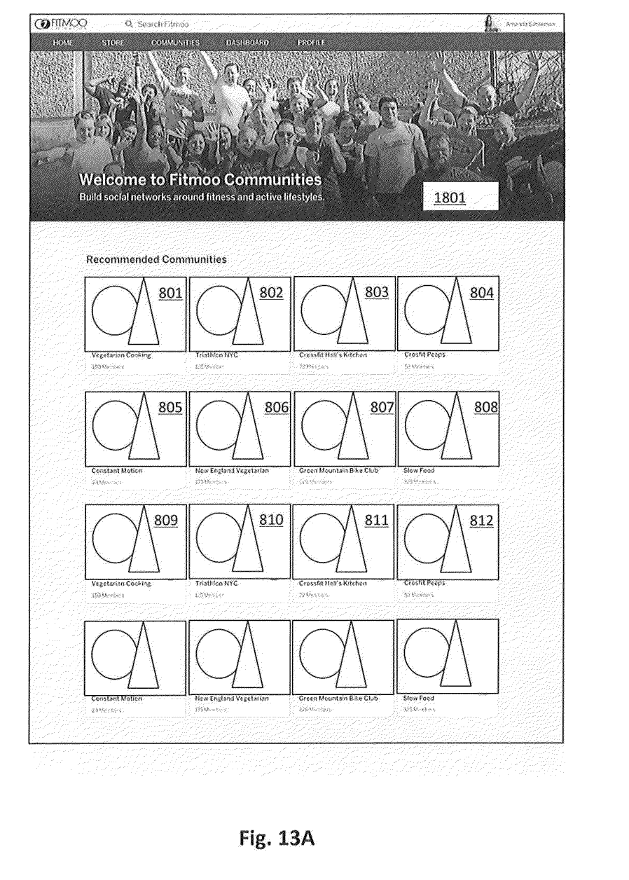

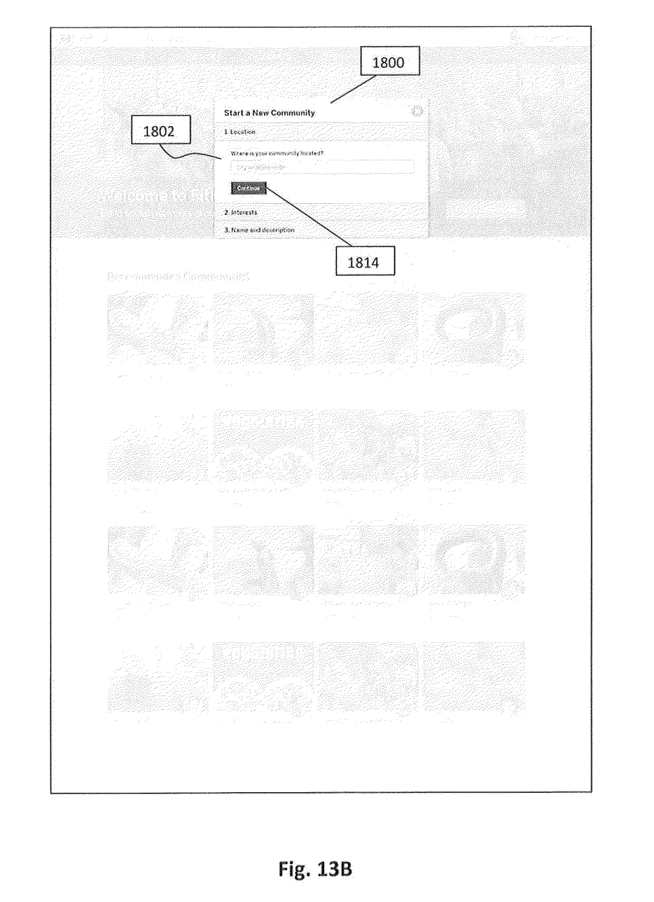

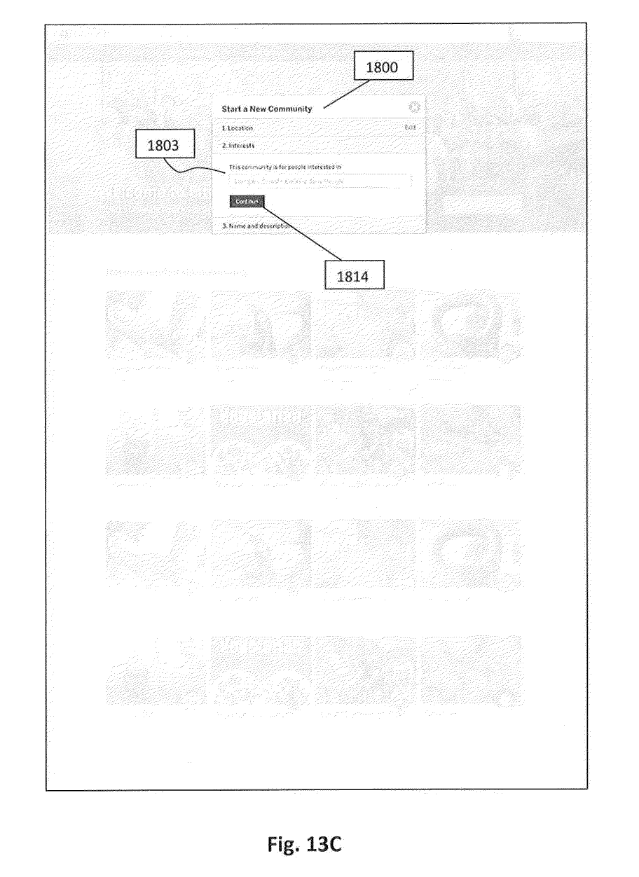

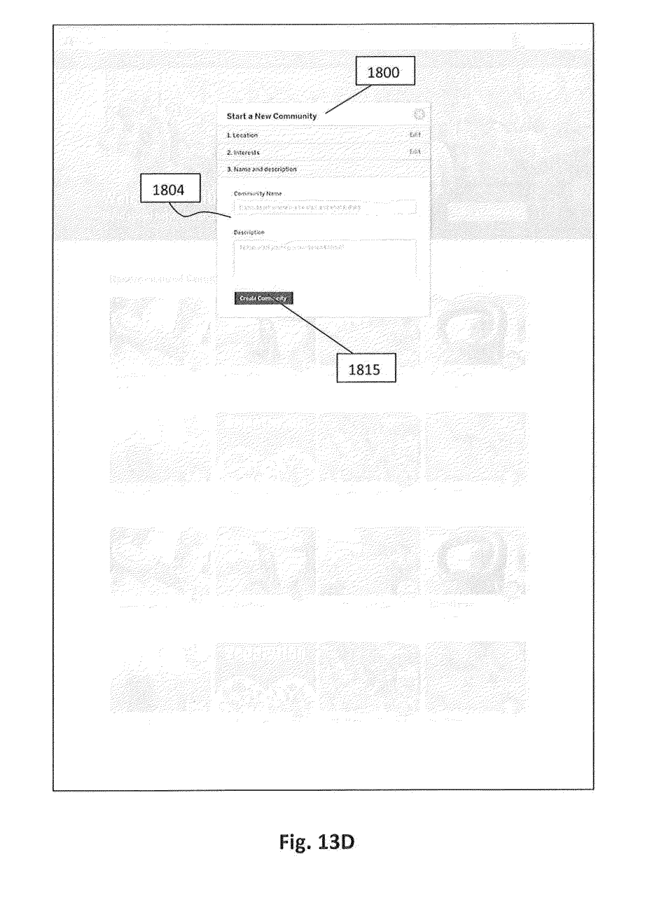

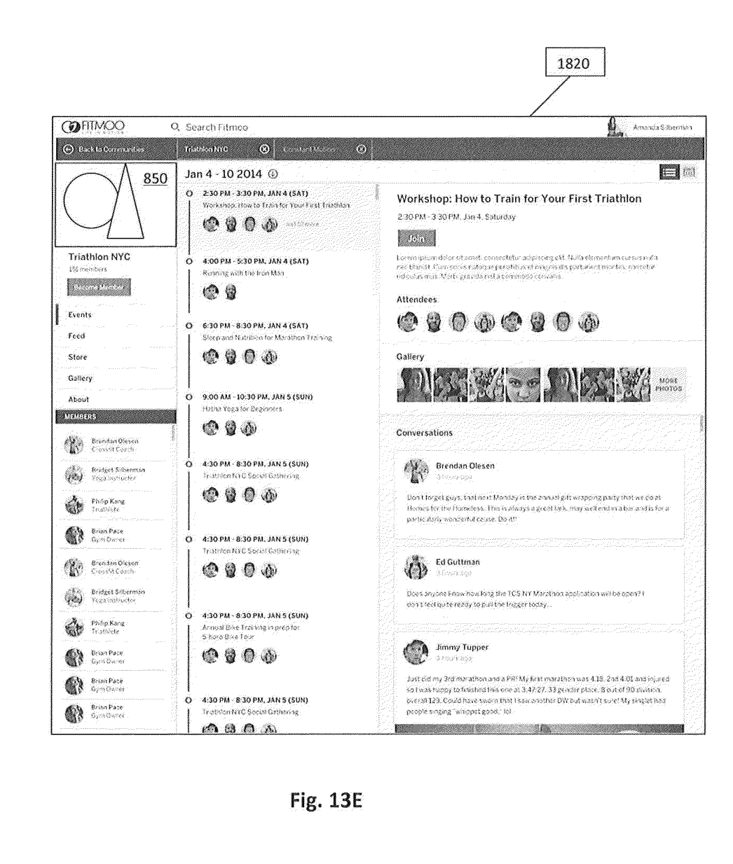

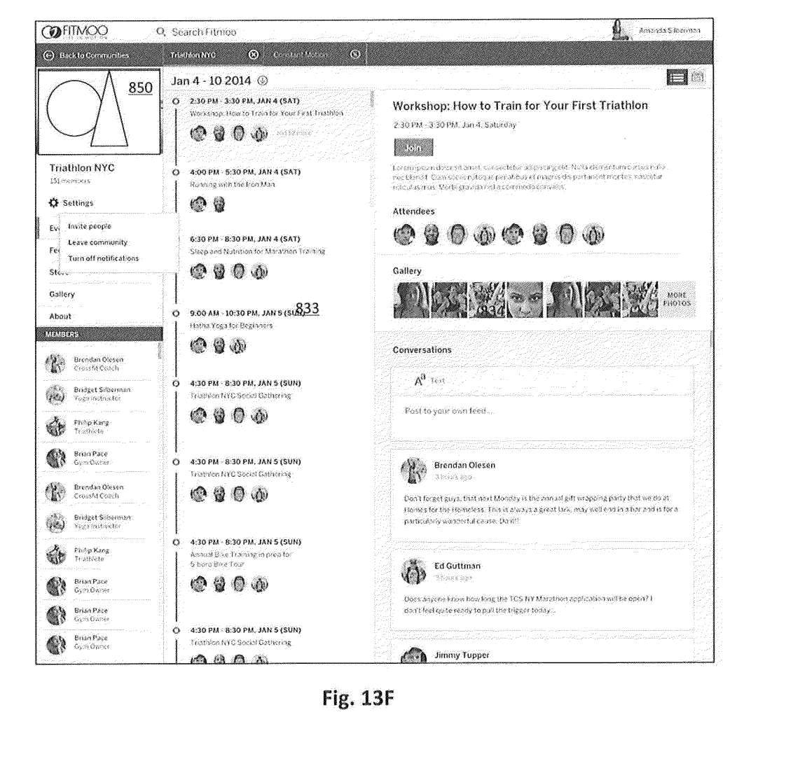

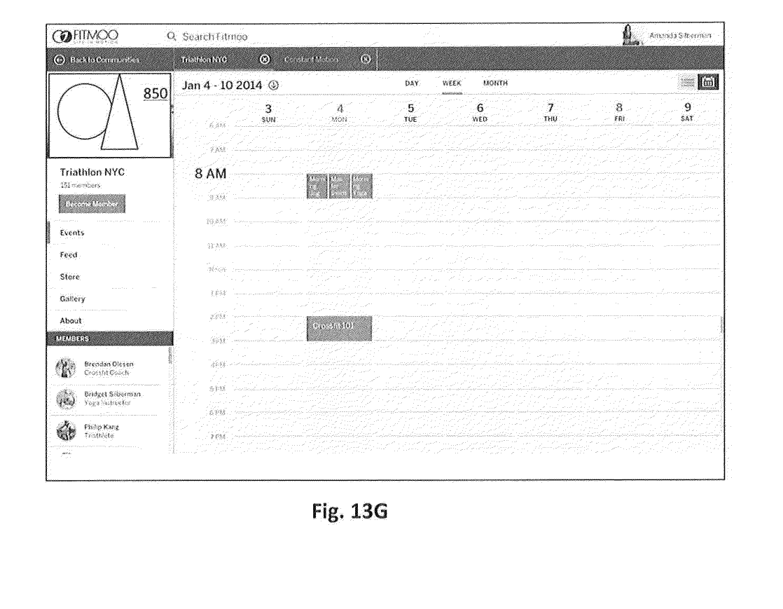

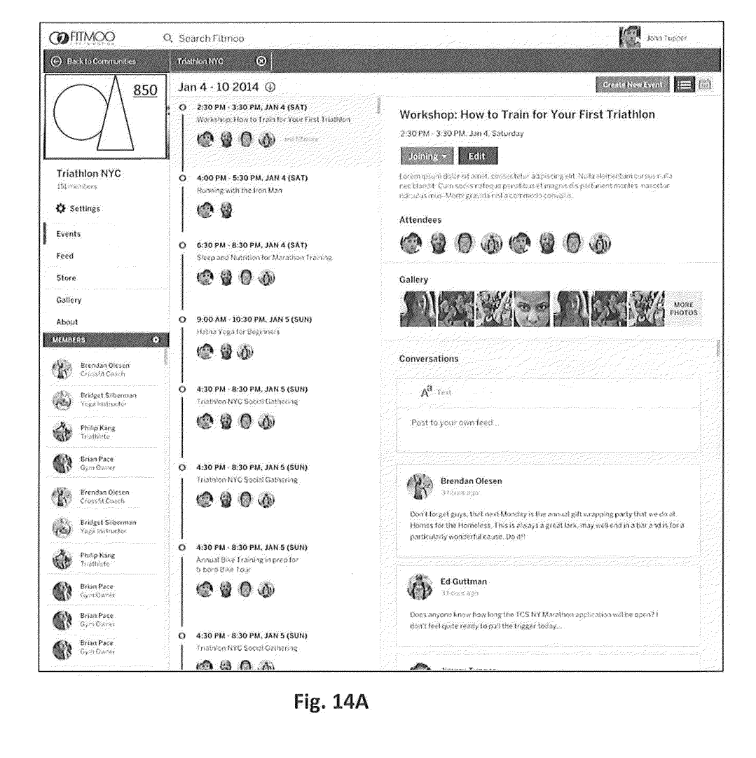

FIGS. 13A-13G illustrate a preferred embodiment for the community site. In accordance to this preferred embodiment, the fitness, health and wellness social e-commerce platform includes a community site where users can view, join or create a community. FIG. 13A illustrates the front page of the community site. In this preferred embodiment a user can browse existing communities. Recommended communities 801-812 are shown based on the user's interests. A user may also create a community by clicking on the “Start a Community” button 1801. This causes the community builder tool to appear as shown in FIG. 13B. The community builder tool 1800 includes three panes 1802, 1803, 1804 where the user will specify the location of the community 1802, the fitness or health related activity the community is interested in 1803, and a name and description for the community 1804. As shown in FIG. 13B, when the community builder tool 1800 opens, the first pane 1802 is shown where the user enters the location of the community. Once the user has entered the location of the community, the user may click on the “Continue” button 1814. As shown in FIG. 13C, this causes the second pane 1802 to appear where the user will enter the interests of the community in the form of keywords. Once the user has entered the interests of the community, the user may click on the “Continue” button 1814. As shown in FIG. 13D, this causes the third pane 1804 to appear where the user will enter the name and description of the community. The user may also select a cover image 850 that will show on the community profile 1820. Finally, the user clicks on the “Create Community” button 1815.

In the example of FIG. 13E, an example of a community is shown where the user is not a member of said community. The user may become a member of the community by clicking on the “Become a Member” button. In this preferred embodiment, a limited profile is available for users that are not member of the community. All community profiles include: “Events,” where user activities are shown in chronological order; a “Feed,” where user posts to the community profile are shown; a “Store,” where user may post their shoppable items and or refer other user to shoppable items in the fitness, health and wellness social e-commerce platform; a “Gallery” of photos and videos, where users may posts photos and videos related to the community; and an “About” page showing basic information about the community and allowing users to share the community in other social networking sites. The profile also shows a list of all members of the community. In the example of FIG. 13F, the user is a member of the community. In that case a “Settings” button allows the user to perform basic functions regarding his or her membership, such as inviting other users to the community, leaving the community or turning off notifications. FIG. 13G shows an exemplary embodiment of the community calendar.

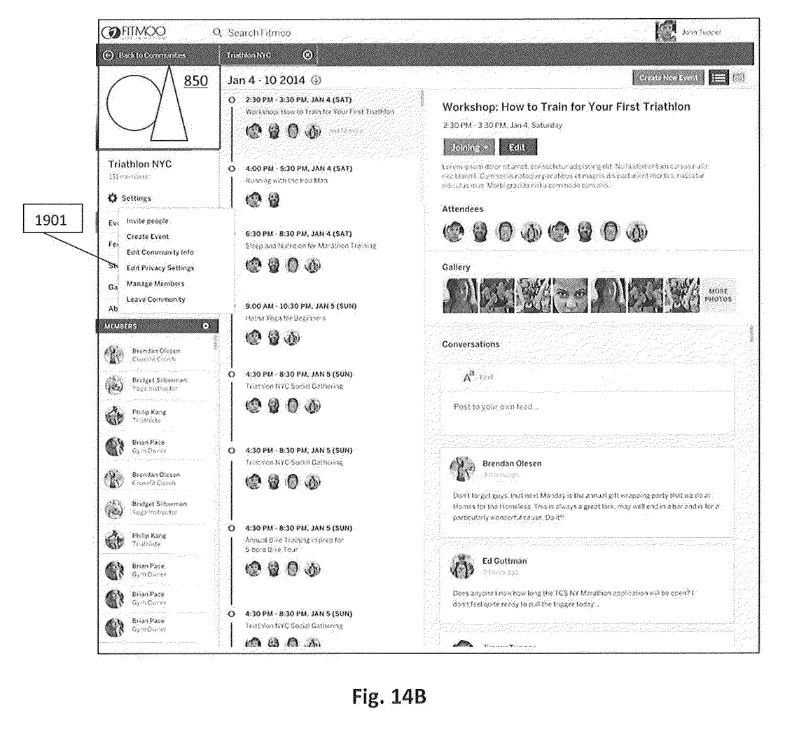

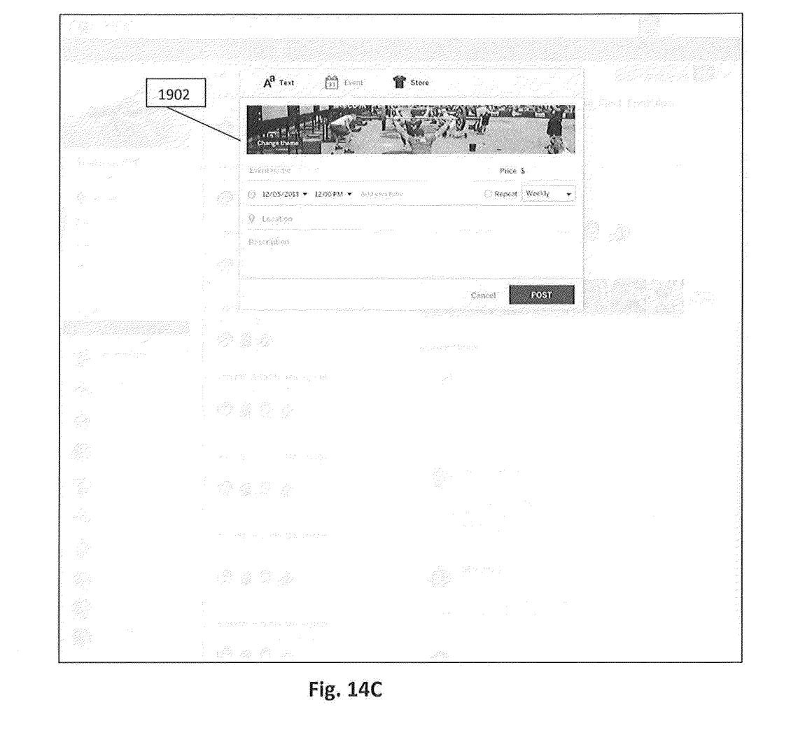

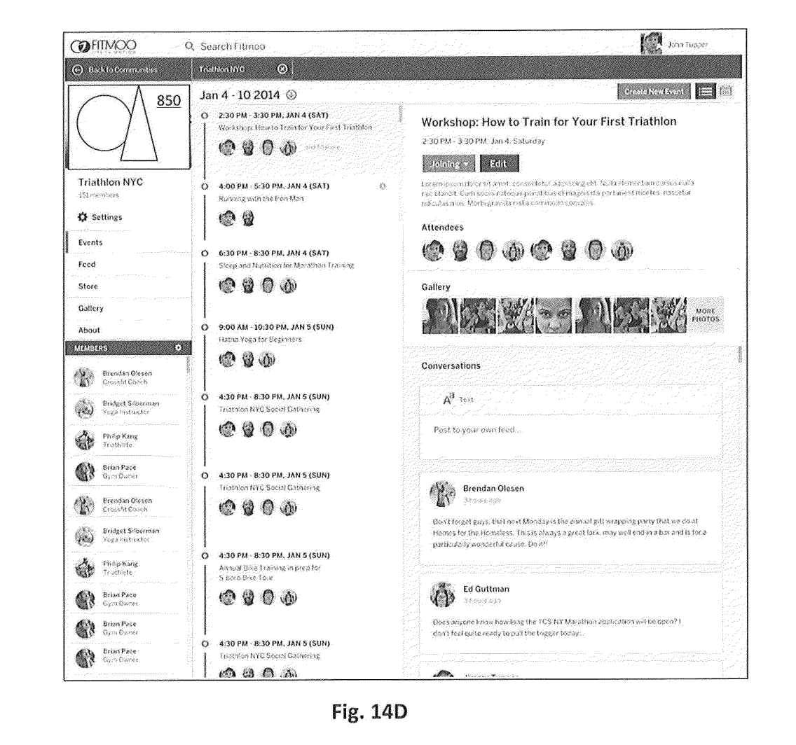

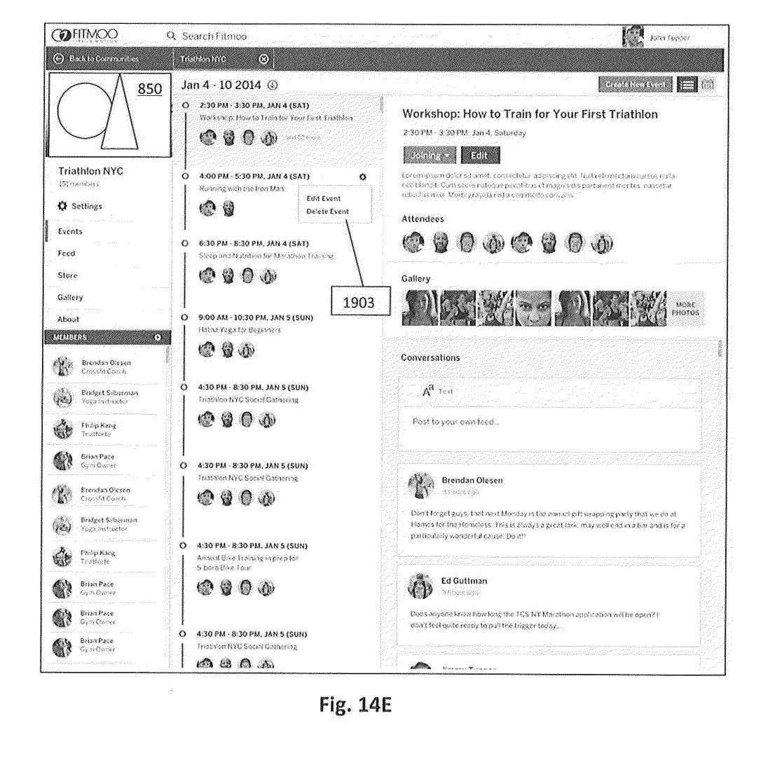

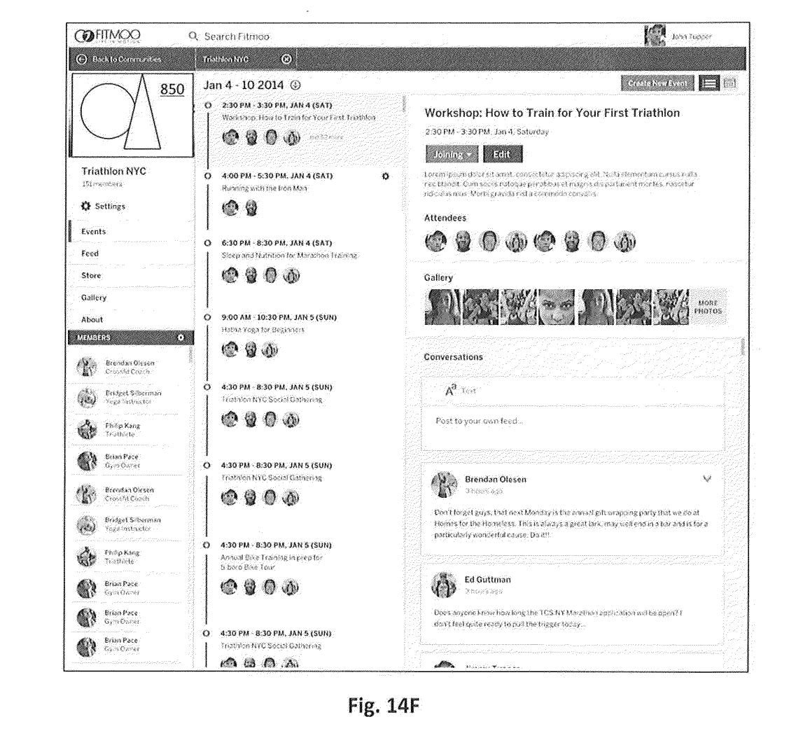

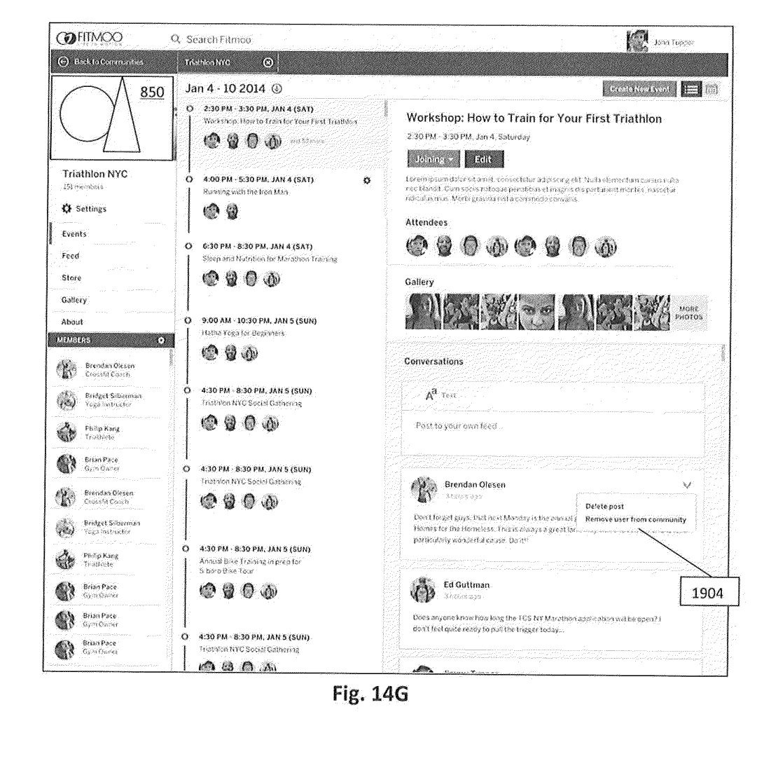

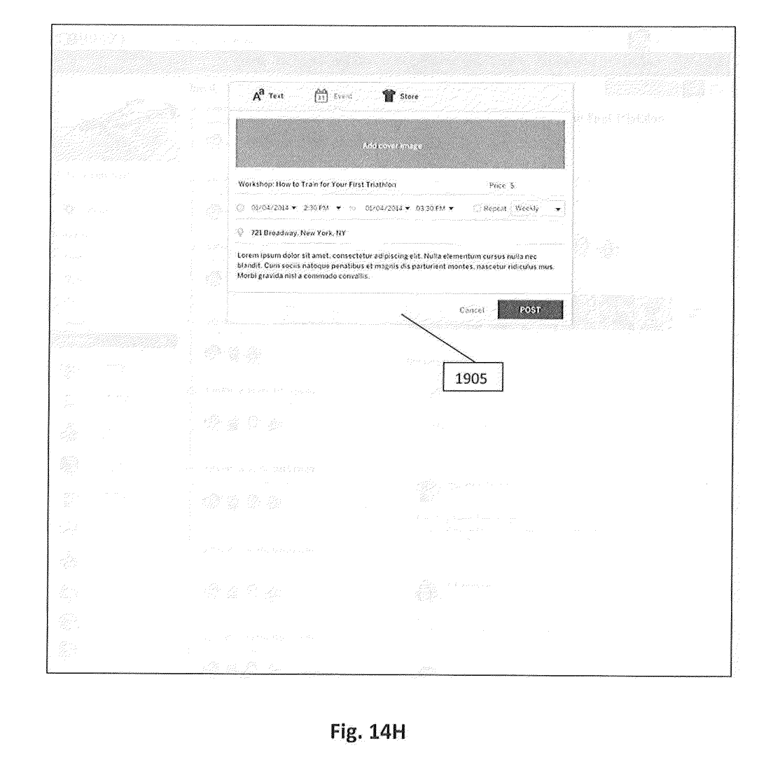

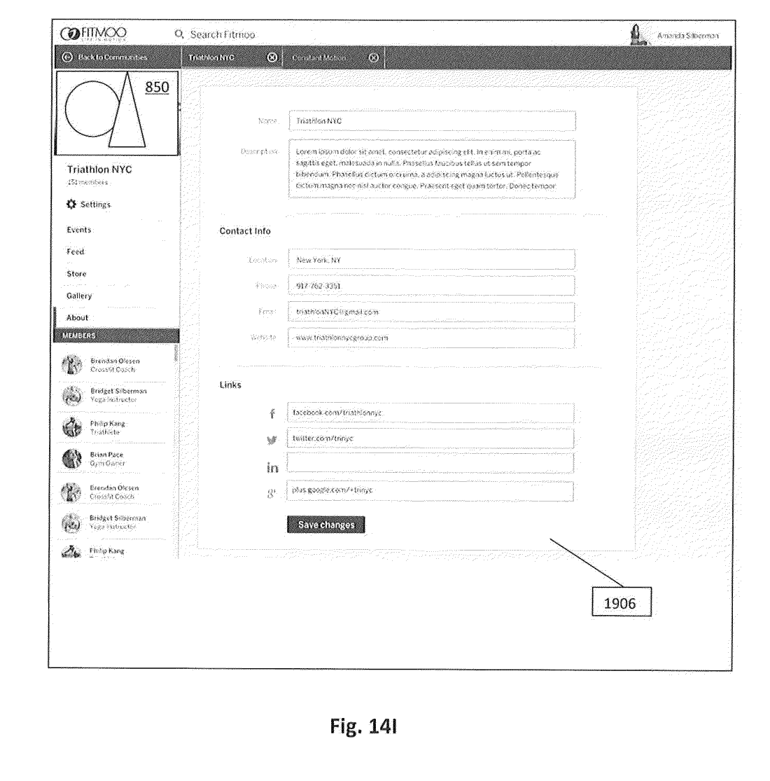

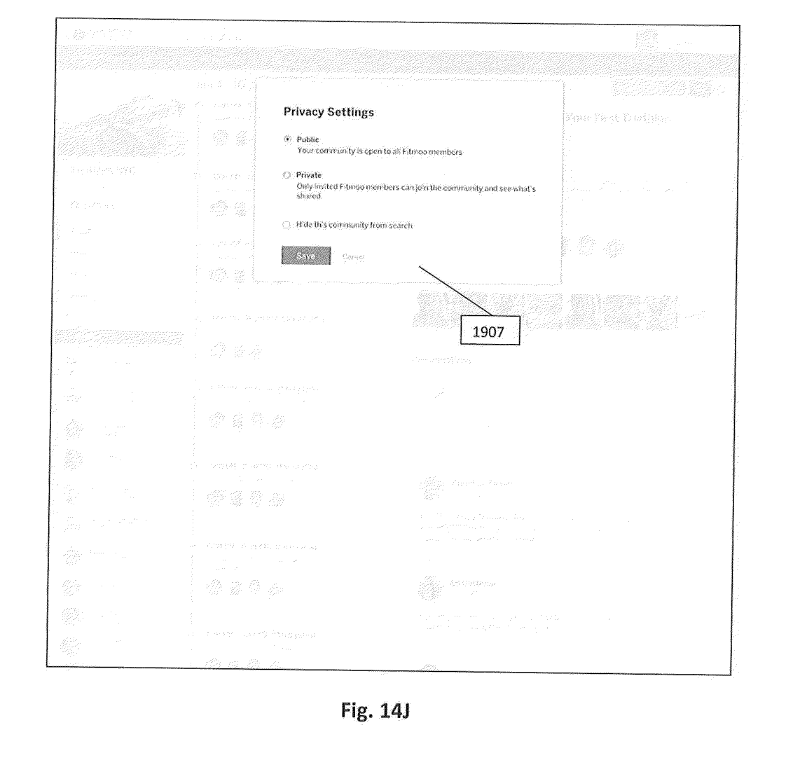

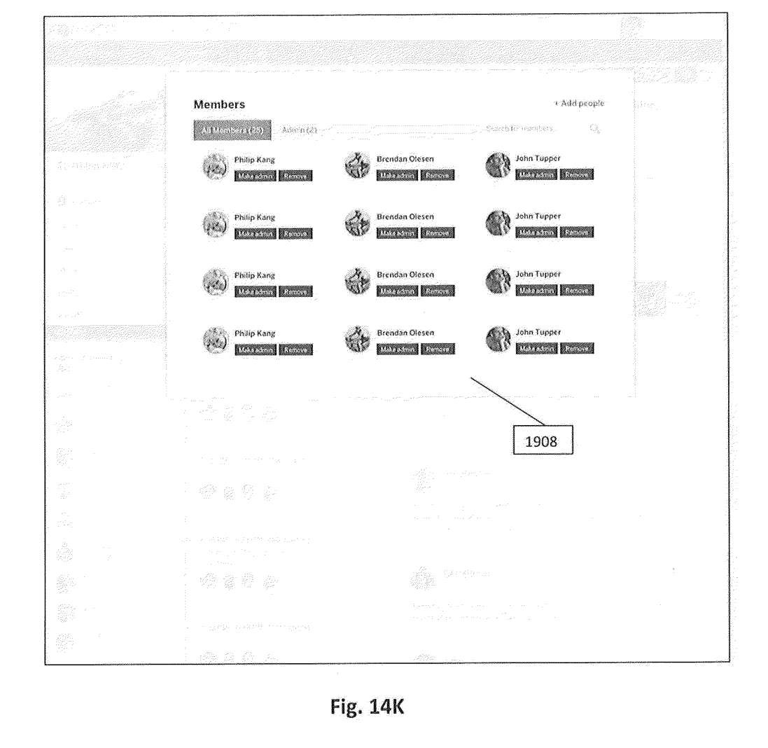

FIGS. 14A-14K illustrate a preferred embodiment for the community profile from the perspective of the administrator of the community profile. In accordance to this preferred embodiment, the administrator of the community profile is able to access options that a normal user cannot access. In the example of FIG. 14B, the administrator of the community profile may invite other users to the community, create events edit the community profile information, edit privacy settings, manage members and leave the community. This is shown in overlay window 1901. The administrator of the community profile is able to create posts, events, and shoppable items and share them with the community as shown in FIG. 14C. The administrator of the community profile is also able to edit and delete events as shown in FIG. 14E. When the administrator clicks on the gear button associated to an event, an overlay window 1903 shows where the administrator is able to choose the action he or she wants to perform. The administrator of the community profile is also able to delete user posts and/or remove users from the community as shown in FIG. 14G. In similar fashion to events, the administrator clicks on the arrow button associated with the post he wants to administer, causing an overlay window 1904 to show where the administrator is able to choose the action he or she wants to perform. FIG. 14H shows the event creation tool for the community profile. The administrator of the community profile may edit the community profile information shown in the “About” page as shown in FIG. 14I. Current community profile information is automatically populated in the text boxes provided for editing in pane 1906 where the administrator is able to edit and click on the “Save Changes” button when the information has been entered. FIG. 14K shows a preferred embodiment where the administrator of the community profile is shown an overlay window 1908 where the administrator may manage the members by adding or removing members from the community or assigning administrator privileges to existing users.

An important aspect of the present invention is that community profiles may be public or private and may be hidden from the search engine. This aspect is shown in FIG. 14J. An overlay window 1907 allows an administrator to choose whether the profile is public or private and whether it can be included in future search results. The Private communities allow fitness professionals and users to engage in eCoaching. Members of the private community are able to: get feedback from each member of the private group on how they are progressing; update workouts and nutrition; set fitness goals; sell products and services from the community store; encourage, interact, share and sell products to members; and allow members of the group to sell items from the community store by putting those items in their store.

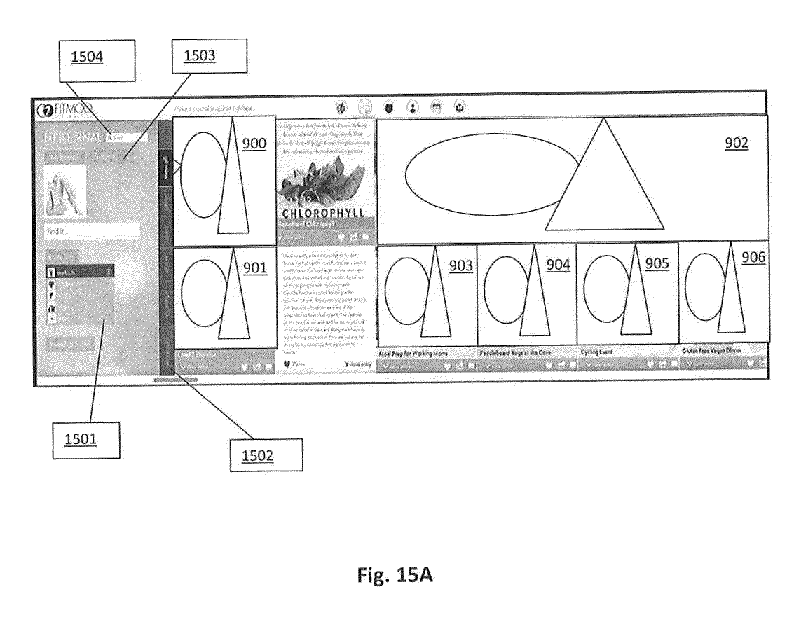

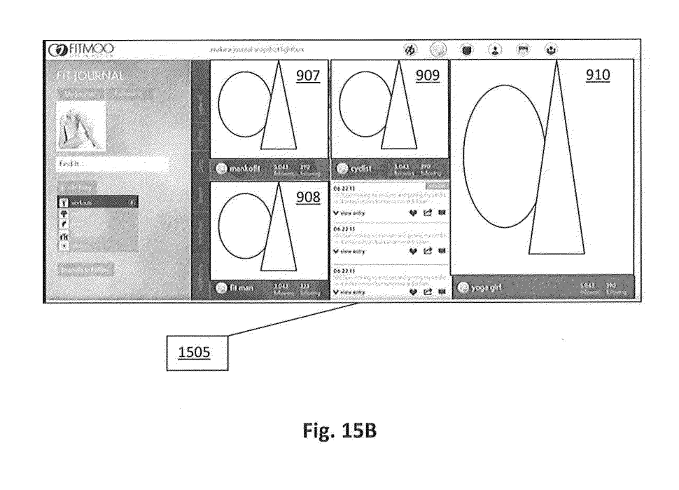

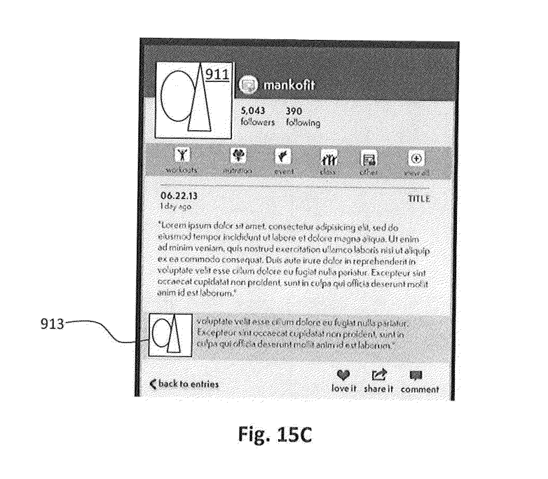

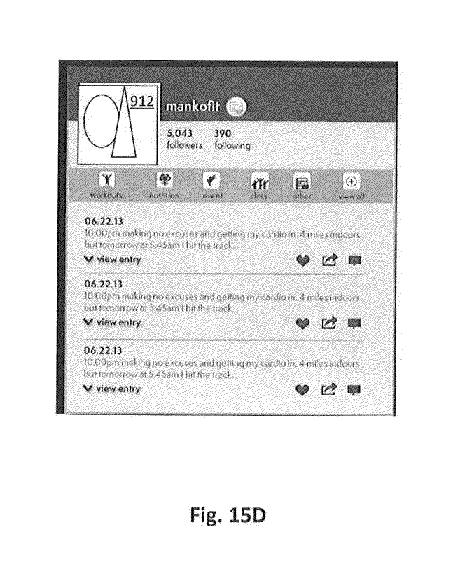

FIGS. 15A-D illustrate a preferred embodiment for the Fit Journal feature of the fitness, health and wellness social e-commerce platform. In accordance to this preferred embodiment, the fitness, health and wellness social e-commerce platform includes a feature that a user may enable on his or her profile to develop his or her “fitness resume” by recording his or her fitness and wellness journey. FIG. 15A illustrates the Fit Journal feature. In this preferred embodiment a user can share events 1501, such as workouts, nutrition, events attended, classes attended, or any other event the user may wish to share with other users. As shown in Fig. A, Events entered by the user, and recorded by the feature, are arranged and displayed in chronological order, thus showing the user's fitness journey from first entered event to latest entered event. It should be noted that each entered event is associated with a photo 900-913. Furthermore, recorded events may include photos 907-910, videos, and/or text 1505 as shown in Fig. B. The Fit Journal feature includes a tab 1502 that allows users to either view all events simultaneously or each event individually, as shown in FIGS. 15C and 15D. Furthermore, the Fit Journal feature includes a tab 1503 with the journals of other users that a particular user may be following. The Fit Journal feature also includes a search tool 1504 to look for the journals of other users.

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the forthcoming claims.

What is claimed is:

1. A system for providing an e-commerce component to a social networking site:
an e-commerce platform comprising a network, a processor, a memory and a storage, wherein said storage further comprises: a) a user profile data store that contains information about a plurality of users; b) a virtual currency data store that contains a balance of virtual currency for each of the plurality of users; c) a shoppable item data store that contains information about the shoppable items; and d) a transaction data store containing a plurality of transactions, wherein the transaction contains information about a shoppable item, a plurality of categories of users associated with the shoppable item and a method of payment;
a virtual currency engine functionally coupled to the processor, the memory, the non-transitory storage and the virtual currency data store, wherein the virtual currency engine is responsive to each transaction by recalculating for each user in the transaction the balance of virtual currency according to the plurality of categories of users and the method of payment.

2. The system of claim 1 wherein the plurality of categories of users comprises a creator of the shoppable item, a consumer of the shoppable item, and a referrer of the shoppable item, if any.

3. The system of claim 1 wherein the shoppable item comprises a calendar event, a post, or a digital content.

4. The system of claim 1 wherein the virtual currency can be exchanged for a real world currency.

5. A computer implemented method for providing an e-commerce component to a social network, comprising:
storing a shoppable item in a shoppable data store along with information related to a creator of the shoppable item;
storing information about a referrer of the shoppable item, if any, along with the shoppable item;
responding to a transaction generated by a consumer of the shoppable item, wherein said transaction includes the shoppable item along with information about a plurality of categories of users and a method of payment used by the consumer of the shoppable item in order to generate the transaction;
retrieving from a virtual currency data store a balance of virtual currency associated with the plurality of categories of users;
calculating the amount of virtual currency to be added or deducted from the balance of virtual currency associated with the plurality of categories of users;
adding to the balance associated with the creator of the shoppable item the amount resulting from recalculating the amount of virtual currency associated with the creator of the shoppable item and the referrer of the shoppable item, if any;
deducting from the balance of virtual currency associated with the consumer of the shoppable item the amount of virtual currency used by the consumer of the shoppable item to generate the transaction; and
storing in the virtual currency data store the balance resulting from recalculating the balance of virtual currency associated with the plurality of categories of users.

6. The method of claim 5 wherein the plurality of categories of users comprises a creator of the shoppable item, a consumer of the shoppable item, and a referrer of the shoppable item, if any.

7. The method of claim 5 wherein the shoppable item comprises a calendar event, a post, or a digital content.

8. The method of claim 5 wherein the referrer of a shoppable item comprises a plurality of referrers of the shoppable item.

9. The method of claim 5 wherein the virtual currency can be exchanged for a real world currency.
